(19) United States
(12) Patent Application Publication
(10) Pub. No.: US 2017/0178207 A1
(43) Pub. Date: Jun. 22, 2017

(54) System and Method for Social Scoring

(71) Applicant: Kari Steinberg, Calabasas, CA (US)

(72) Inventor: Kari Steinberg, Calabasas, CA (US)

(21) Appl. No.: 15/288,537

(22) Filed: Oct. 7, 2016

Related U.S. Application Data
(60) Provisional application No. 62/239,836, filed on Oct. 9, 2015.

(51) Int. Cl. G06Q 30/02

(52) U.S. Cl. CPC G06Q 30/0282

(57) ABSTRACT

A method for receiving and publishing reports includes: receiving, by a processor, a report from a giver user; generating, by the processor, a report code associated with the report; associating, by the processor, the report code with a profile of a Receiver user; receiving from the Receiver user, by the processor, an approval or a rejection of the report associated with the report code; and publishing, by the processor, the report on the profile of the Receiver user if the processor received the approval of the report.

### CROSS-REFERENCE TO RELATED APPLICATION

This patent application claims the benefit of U.S. Provisional Patent Application Ser. No. 62/239,836, entitled “System and Method for Social Scoring,” filed Oct. 9, 2015, which application is incorporated in its entirety here by this reference.

### FIELD OF THE INVENTION

The invention relates to crowd sourced review systems and in particular to a system wherein giving users submit reports regarding receiving entities wherein the receiving entities may be people, businesses, locations such as landmarks, or performances such as musical performances and the like, wherein a score based upon predetermined criteria is determined for the receiving entities based upon the reports received by the giving users.

### BACKGROUND OF THE INVENTION

Crowd sourced review systems are used in a variety of contexts in which the general public may submit reviews and ratings of businesses, services, and people. For example, consumers may review local businesses such as restaurants and hair salons using the Yelp® website. Similarly, employees and employers can write testimonials about their prior and current co-workers in the LinkedIn® website and service providers such as plumbers, roofers, and doctors may be reviewed using the Angie's List® website.

Existing review systems do not provide ways to “rate” a stranger and rather only allow you to “rate” someone that you know in some way. While it may be easy to rate a place without having ever been there, it is difficult to rate a person without knowing something about them in order to identify them. There are no existing ways to “rate” or to make a comment about “the guy I met on the plane that was really nice and smart and seems like a great marketing person” because there is no place to publish a review about “that guy” that people would see, nor is there a way to find all reviews associated with that person. In addition, “that guy” may never want to give out any personal information to you and therefore you would have no way to “rate” him or even acknowledge him, whether privately or to the world.

### SUMMARY OF THE INVENTION

Aspects of embodiments of the present invention are directed to systems and methods for social scoring and a tool or utility to acknowledge goodness and good deeds. By providing public acknowledgment of goodness and good deeds (of people, places, products, and play), embodiments of the present invention may inspire people to look for the good in others and to do good deeds themselves. As such, embodiments of the present invention may be used as a stand-alone tool, allowing a person, place, product, or play the opportunity to earn points for receiving acknowledgments of goodness and good deeds, without requiring participation in any social network or scoring system. Embodiments of the present invention also provide ways for people to rate Strangers without requiring the strangers to provide personal information (e.g., without an email address, phone number, website, or even a name). In some aspects of embodiments of the invention, reports or comments are provided to a user and a user may approve or reject comments or approve the comments with a portion edited out.

Aspects of the present invention allow all aspects of the reports and comments to be permissions based. A giver or giving user can provide reports or comments without an account and a receiver or receiving entity can choose to receive a report without having an account. Users can also opt out of having a score or can opt out from being visible in a searchable database, based on the permissions that the users have set.

According to one embodiment of the present invention, a method for receiving and publishing reports includes: receiving, by a processor, a report from a giving user; generating, by the processor, a report code associated with the report; associating, by the processor, the report code with a profile of a receiver user or entity; receiving from the receiver entity, by the processor, an approval or a rejection of the report associated with the report code; and publishing, by the processor, the report on the profile of the receiver entity if the processor received the approval of the report. A receiving entity may be a person, a business, a location such as a landmark, or a performance such a musical performance or a play.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a schematic diagram illustrating the interactions between people and a system according to one embodiment of the present invention.

FIG. 2 illustrates exam ways in which a code for a person or a business may be displayed according to some embodiments of the present invention as displayed on a small screen device such as smartphone or a table or on a large screen device such as a television, but embodiments are not limited thereto.

FIGS. 3A, 3B, 3C, 3D. 3E, 3F, 3G, and 3H are schematic illustrations of user interfaces for various aspects of embodiments of the present invention.

FIGS. 4A, 4B, and 4C are schematic illustrations of user interfaces on small screen devices such as smartphones and tablets or on a large screen device such as a television for various aspects of embodiments of the present invention.

FIG. 5A is a flowchart illustrating user interaction paths through a system according to one embodiment of the present invention.

FIG. 5B is a flowchart illustrating a method for accessing, editing, and a member profile according to one embodiment of the present invention.

FIG. 5C is a flowchart illustrating a method for filing a report (or “GPR”) according to one embodiment of the present invention by a member.

FIG. 5D is a flowchart illustrating a method for filing a report (or “GPR”) according to one embodiment of the present invention by a non-member.

FIG. 5E is a flowchart illustrating a method for receiving, by a member or non-member, a report (or “GPR”) according to one embodiment of the present invention.

FIG. 5F is a flowchart illustrating a method for searching a database of reports and users according to one embodiment of the present invention.

FIG. 5G is a flowchart illustrating methods for a retail store, its customers, and its employees to interact with a system according to one embodiment of the present invention.

FIG. 5H is a flowchart illustrating a method for various revenue models for monetizing a system according to one embodiment of the present invention.

### DETAILED DESCRIPTION OF THE PREFERRED EMBODIMENTS

In the following detailed description, only certain exemplary embodiments of the present invention are shown and described, by way of illustration. As those skilled in the art would recognize, the invention may be embodied in many different forms and should not be construed as being limited to the embodiments set forth herein. Like reference numerals designate like elements throughout the specification.

Aspects of embodiments of the present invention are directed to systems and methods for receiving reports or comments (or good {person, place, play, product} report or “GPR” reports) to provide social scoring of a variety of things, including people, places, play (or entertainment including “media”), and products based on who (or what) they are, rather than what they do. In other review systems, reviewers make judgments about the acts done by people or places. In contrast, in embodiments of the present invention, givers or giving users of reports provide judgment-free “gifts” or “acknowledgments” of good deeds or good things, thereby providing ways of acknowledging goodness as opposed to reviewing actions or features of the reviewed subject matter. In embodiments of the present invention, the comments associated with a report provide the justification and description of the good deed or good thing, and the cumulative score (e.g., number of good reports) indicates a cumulative “goodness” of the subject.

Aspects of embodiments of the present invention are directed to systems and methods for generating codes associated with particular reports. Aspects of embodiments of the present invention are also directed to displaying live streaming data (e.g., of social scores) to leader boards and organizing the data in a useful and convenient way, such as separating and organizing people, places, products, and play environments for social scores. Live streams may also be displayed at locations (e.g., in a window or storefront, such as adjacent to a mandated rating letter), on websites (e.g., a personal webpage, on a social media profile page, on the website of the corresponding business, etc.) Aspects of embodiments of the present invention are also directed to associating users of the system having similar attributes or common goals. Aspects of embodiments of the present invention are also directed to integrating social scoring into existing social media networks (e.g., using a dynamic toolbox or insert). Aspects of embodiments of the present invention are also directed to categorizing social score reports based on person, place, product, or play.

For example, in existing social rating systems such as LinkedIn®, Angie's List®, and Yelp®, ratings are submitted by users based on particular actions performed, where those ratings are based on a scale (e.g., in a range from 1 to 5 or in a range from 0 to 100). Therefore, the accumulated ratings are constrained to a value within the scale. For example, in a social rating system where restaurants are rated on a scale of 1 star to 5 stars, a particular restaurant may have a score that is the average (e.g., arithmetic mean) of all of the ratings given to it (e.g., 4.4 stars).

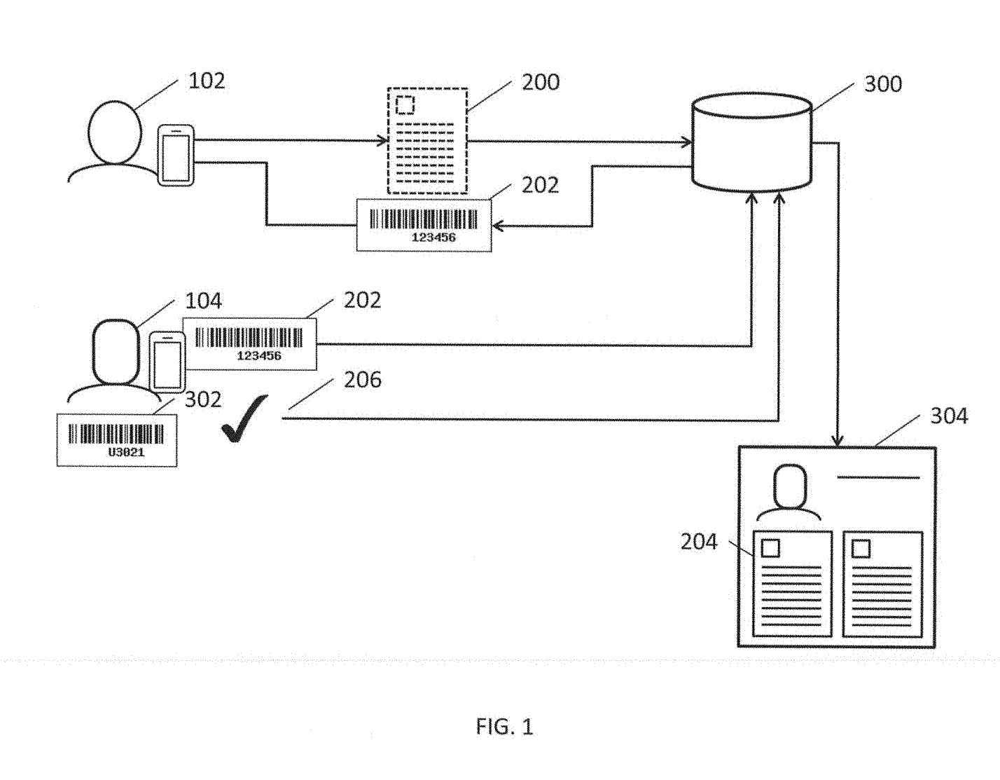

One aspect of embodiments of the present invention allows for the social scoring of people, including strangers. FIG. 1 is a schematic diagram illustrating the interactions between people and a system according to one embodiment of the present invention. For example, as shown in FIG. 1, two people 102 and 104 may meet and have an encounter such as an extended conversation or such as a customer and a waiter, however embodiments of the invention are not limited thereto and the two people 102 and 104 may never actually speak to each other. At the end of the encounter, one of the people (the “giver” or “giving user” or “reviewer”) 102 may decide to file a report (or “comment”) 200 on the second person (the “receiving entity” or “reviewed user” or “receiver”) 104, describing the reviewed person as being a good person by virtue of the positive encounter that the two people shared. (The report may include information such as the substance of the conversation and the Giver's perception of the reviewed person's qualities as an individual. The report 200 may be transmitted and stored on a server 300 and a unique code (or “report identifier” or “report code”) 202 may be generated for that comment. For example, in the case of a customer and a waiter, the customer may file a GPR on the waiter and may provide his Unique GPR code on a napkin and leave it for him to receive his GPR without ever speaking with him or learning anything about him or receiving any identifiable information.

The unique code 202 for that report 200 may then be given to the reviewed user 104, who can use the unique code to access the report 200 stored on the server 300. By providing the report code 202 to the server 300, the reviewed user 104 associates the corresponding report 200 with his or her member account on the server 300. After reading the report, the reviewed user 104 can choose to accept 206 or reject the report 200. Accepted reports 204 may become part of the 10 reviewed user's public profile 302. Rejected reports and reports that have not yet been approved remain private (e.g., they may be deleted from the server 300 or merely do not appear on the user's public profile). Negative reports can be deleted and can be flagged for follow up. Givers who give negative reviews may have their accounts flagged for negativity, their own scores reduced, or may have their accounts deleted.

A reviewed user 104 may receive a report 204 that contains portions that he or she likes and portions that he or she dislikes. In some embodiments of the present invention, the reviewed user 104 may selectively hide or delete portions of the report 204, but not add more material to the report. For example, the report may include a comment such as “he is cute” and the reviewed user 104 may choose to delete this portion while keeping the remaining portions of the comment. When the report is displayed, it may include a notice that the report was edited. This prevents Givers from gaming the system by burying negative comments within a mostly positive report.

The reports received by the reviewed user may be used to generate a score for the user. For example, a user's score may be based on the number of reports received. As another example, a weighted score where some user's reports may be more significant than others (e.g., users having higher scores may be given more weight than users having lower scores). As such, the scores are not limited to a particular range of values. In contrast to social rating systems that rate their subject matter on a scale, systems according to embodiments of the present invention receive reports that are given to acknowledge, for example, a person's goodness or good deed, and the system generates a score based on the number of reports filed on the subject. These points translate into many values such as showing others how much they do that is good, earning gifts from participating sponsors, getting jobs or dates or new business, customers or an apartment or a loan etc. based on how many points they have earned.

Therefore, scores of people can be used to evaluate their trustworthiness and competence. A person's GPR score can be used to determine many things such as whether the person is worthy of a loan (e.g., to purchase a car) or qualified to be the best babysitter for your child, etc. Embodiments of the present invention can pull out key “features” of an individual based on many GPR's (e.g., common phrases or adjectives used to describe the individual in the GPRs) and a mathematical model or algorithm can suggest a level of “goodness” or trustworthiness or reliability or capability, etc. based on specific needs. This information can be synthesized into a type of metric or “Secret Sauce” that can help an employer decide whether to hire a new employee, predict the likelihood of a good date, etc. not just for that one individual but when compared to other specific individuals. In some embodiments, these reports can be paid for. In some embodiments, access to these reports may be controlled by the person and may be submitted only if the person gives permission to have their GPRs “evaluated” by our system. An employer might insist upon this as a requirement of new employment much like some companies insist on psychological evaluations.

In some embodiments of the present invention, the filed and accepted reports are monitored, e.g., by human moderators of the system or natural language processing systems to ensure that all reports (or comments) reflect positively on their subject matter. Reports that are negative about the person, place, product, or play may be hidden or deleted from the system, or otherwise made invisible to users and these negative reports may be ignored for purposes of computing a score for the reviewed user.

In more detail, in one embodiment, the unique code 202 may take on any of a number of forms, so long as the code is unique to a particular report 200 at any given time. For example, previously used codes may be reused after their associated reports have been accepted into a user profile. The code may be a sequence of numbers (e.g., as shown in FIG. 1), a sequence of letters, a phrase (e.g., a saying or a quote), a picture or a barcode or QI code that stores a particular sequence, etc.

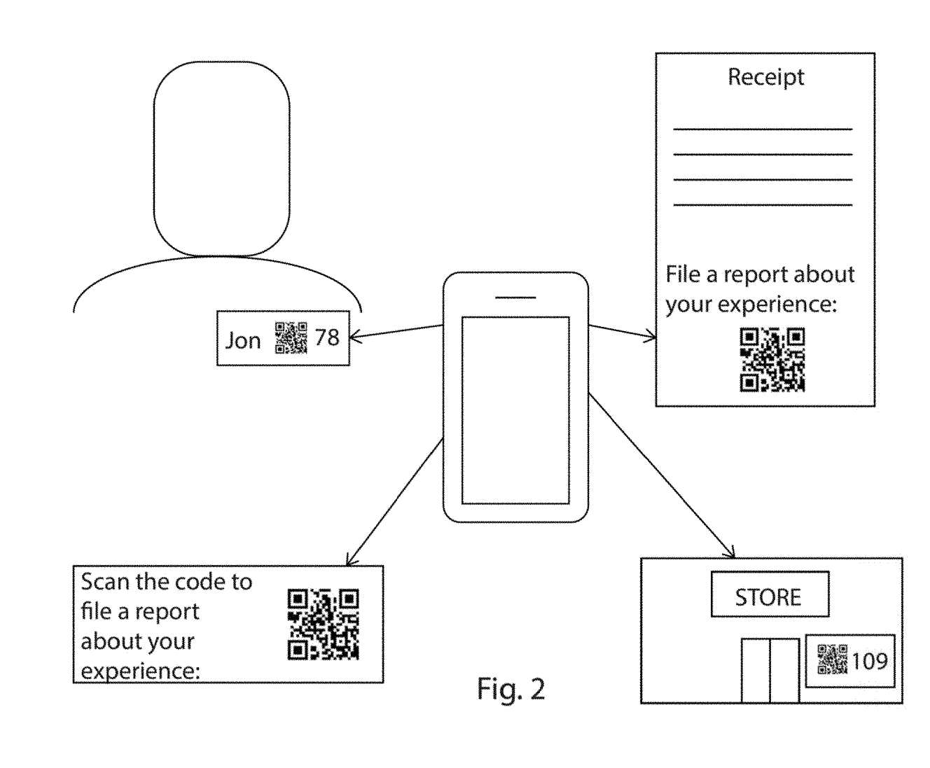

In addition, in some embodiments of the present invention, people can be associated with personal codes. Similarly, businesses and products can also be associated with codes specific to those businesses or products. FIG. 2 illustrates example ways in which a code for a person or a business may be displayed according to some embodiments of the present invention, but embodiments are not limited thereto. FIG. 2 also illustrates that a computing device such as a smartphone can be used to scan the codes displayed in various places. For example, a reviewed person 104 having a public profile 304 may have an assigned personal code 302. Such personal codes may be published (e.g., on social networking sites and business cards) so that other people can easily access the profile of the reviewed person 104 and also easily contribute reports of the reviewed person. A personal code may also be printed (e.g., as a barcode or QR code) on a removable portion of a nametag (e.g., the removable portion may be magnetically attached), so that a potential Giver can easily scan the personal code as shown in FIG. 2. In some embodiments, the personal code is stored in a Bluetooth capable device such as a name tag, jewelry, a sign, a phone, a smart device, etc. so that a Giver can easily identify the personal code that the report should be associated with. A person's personal code 302 may also be associated with personally identifying characteristics such as a password, fingerprints, retinal scan, signature, and photographs.

Codes for business may also be shown, as shown in FIG. 2, on receipts, on signage at the store (e.g., at the checkout register or outside the storefront). Codes for products and entertainment may be shown on the packaging of the products or on the finished goods themselves (e.g., printed onto a CD or DVD or as a label on the bottom of a toy).

FIG. 2 also shows that scores can be shown in real time. For example, a name tag may be a digital name tag that automatically updates based on the wearer's current GPR score. Similarly, a sign outside of a store may include a live display with its current GPR score.

Furthermore, when a report is filed by a user who has her own personal code, the report is also tagged with that filer's personal code. This allows users to write reports and leave their own recognizable electronic signatures on the reports. Readers of those reports can then examine the Giver's profile to determine whether or not the Giver is trustworthy when the Giver has chosen to provide the report under their own identity. In some embodiments, the Giver may provide a report anonymously.

In some embodiments, whether the Giver remains anonymous or not, when the reviewed user enters the code to receive the report, the Giver's stats are listed. This allows the reviewed user to use the information to determine if the Giver is credible. For example, a person with bad intentions may want to say something negative to a reviewed user by way of a report. Although the Giver may know that the Receiver will delete the report, the reviewed user's feelings may be hurt anyway when reading the report. As noted above, while users who file negative reports may have their personal scores decreased or their accounts deleted, in some embodiments, new accounts are flagged such that Givers can be aware that the Giver may have created a “throwaway account” to send a negative review. By listing stats regardless of whether or not the Giver is anonymous, the Receiver can see that if someone has given very few or no other reports (or GPRs) there can be a warning that caution is advised due to the low number of GPRs filed by the Giver suggesting the possibility of a negative review.

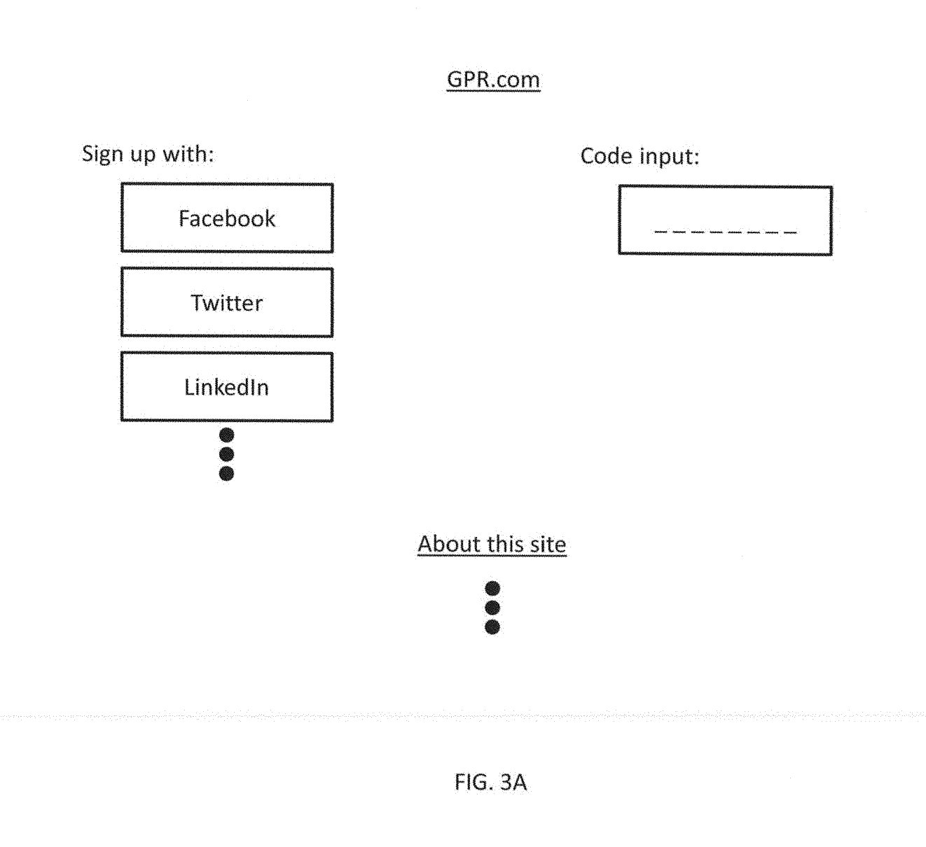

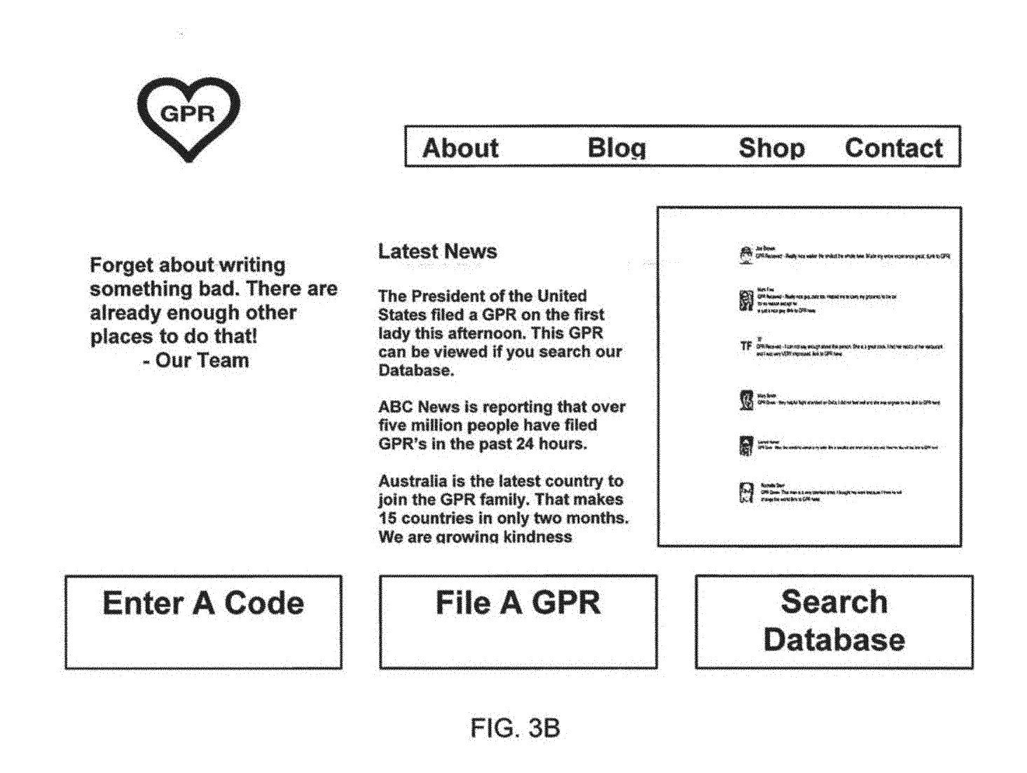

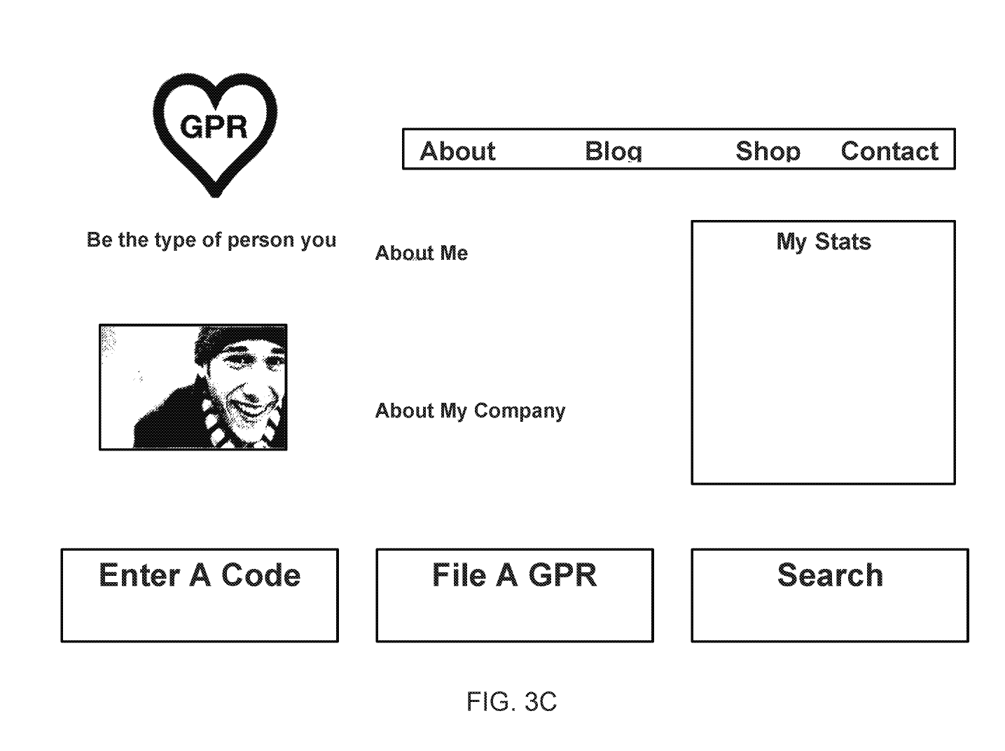

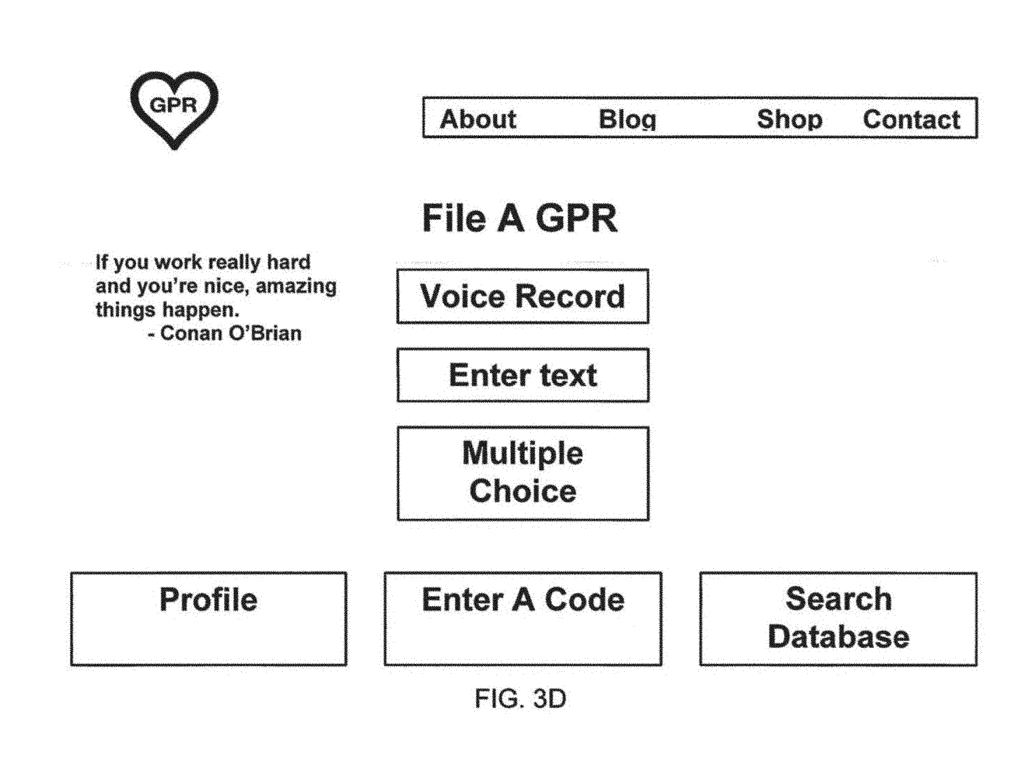

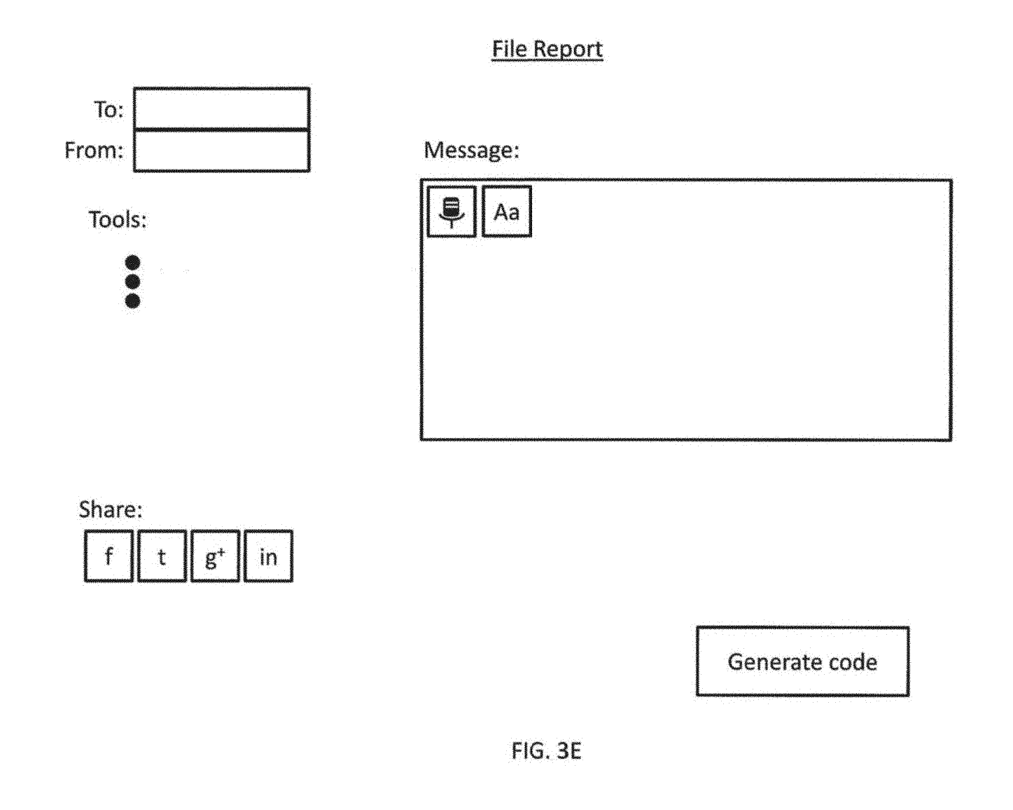

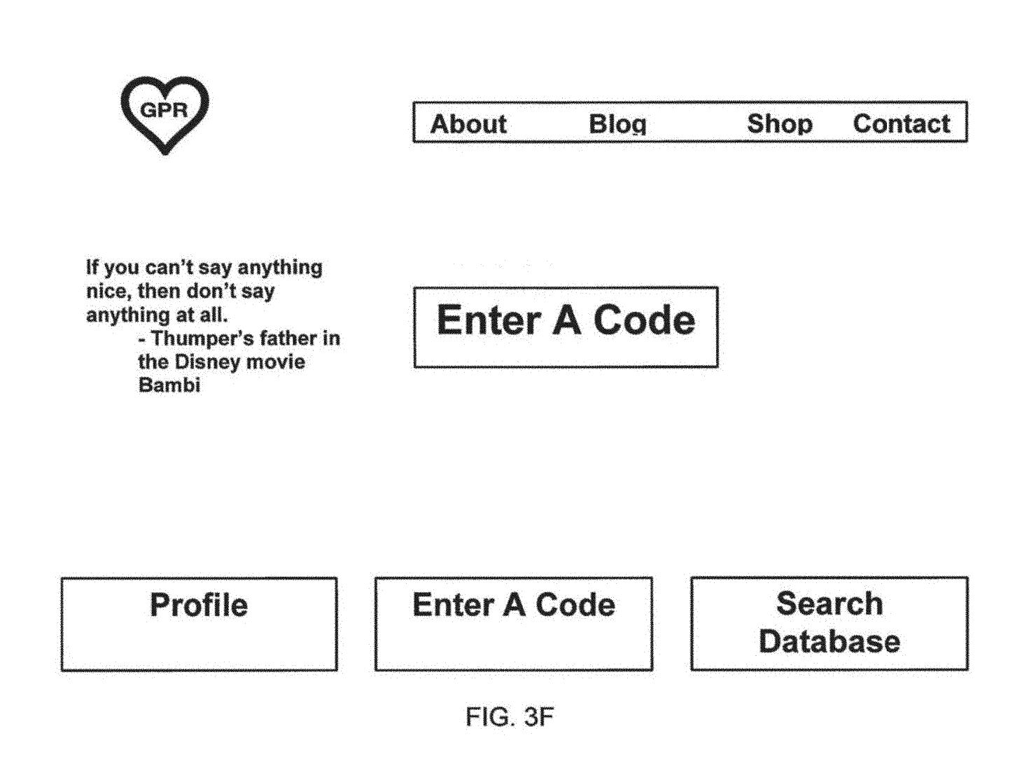

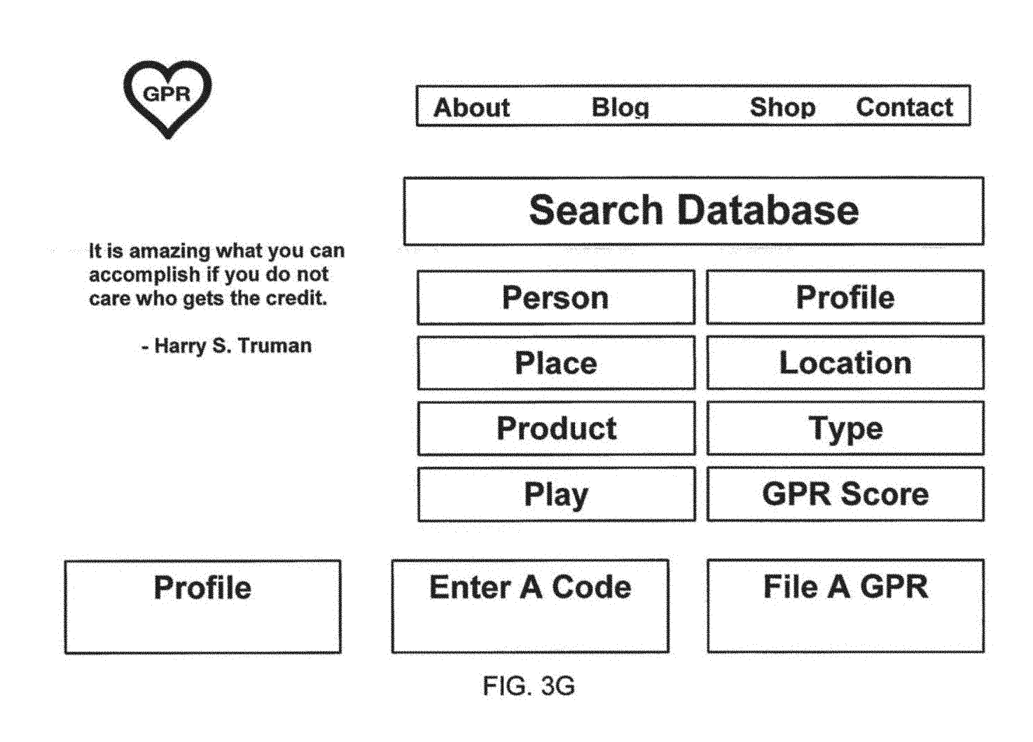

In more detail and referring to FIGS. 3A, 4A, and 5A, according to one embodiment of the present invention, a new user accesses a social scoring system through, for example, a website or a mobile device. The user clicks on a “register” button and may be prompted for personal information such as an email address, password, zip code or other geographic code, and an indication of gender in order to register the user as a “member,” or may sign up using an account on an existing social network such as Facebook®, Twitter®, or LinkedIn®, as shown, for example, in FIG. 3A.

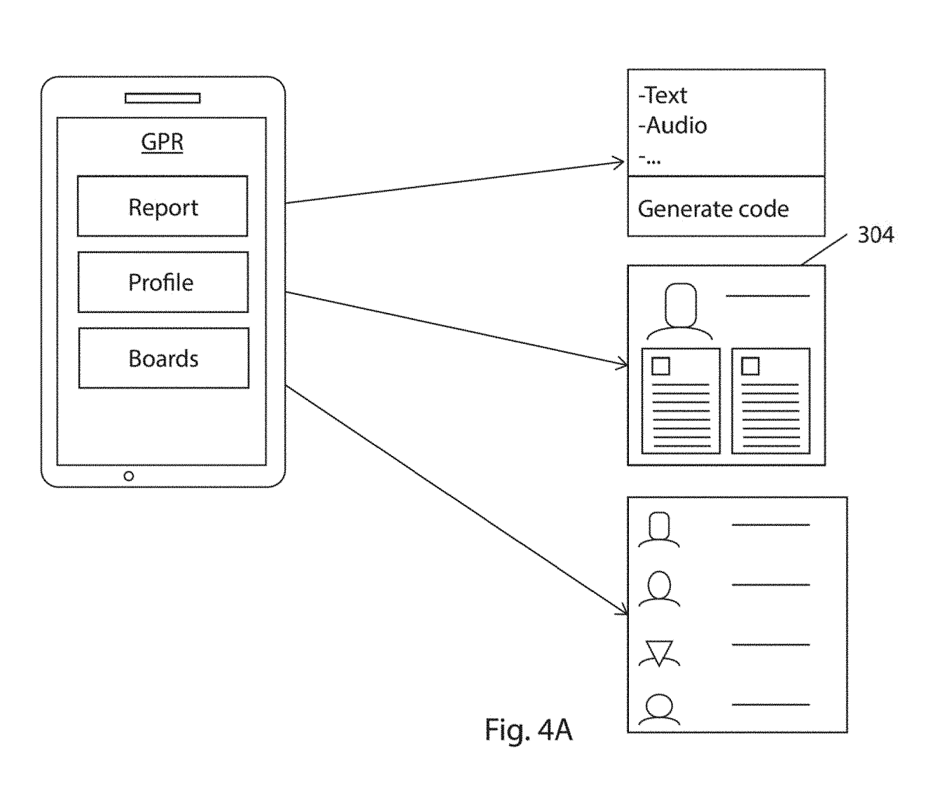

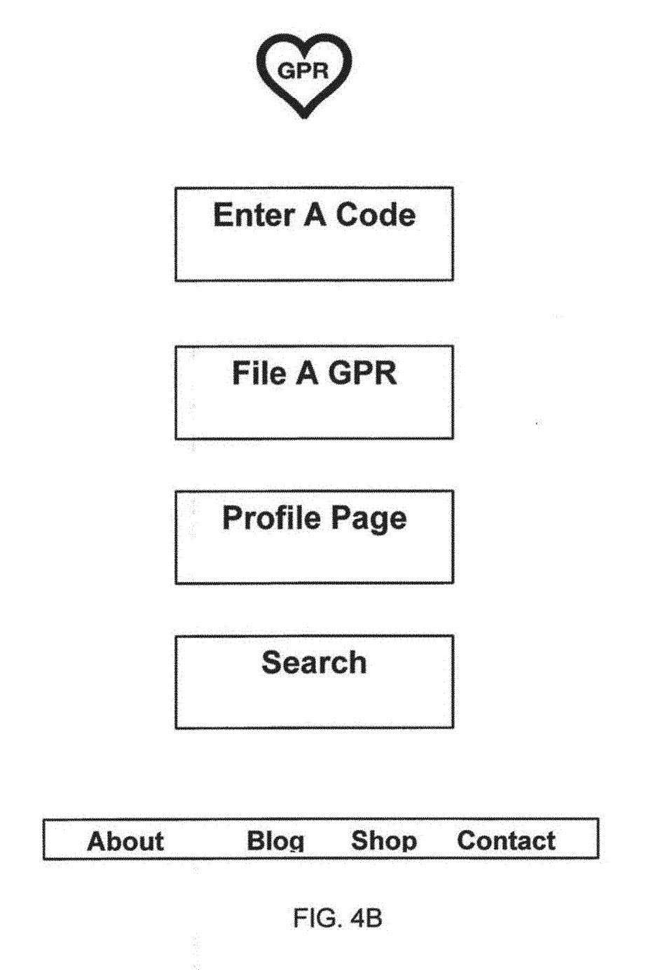

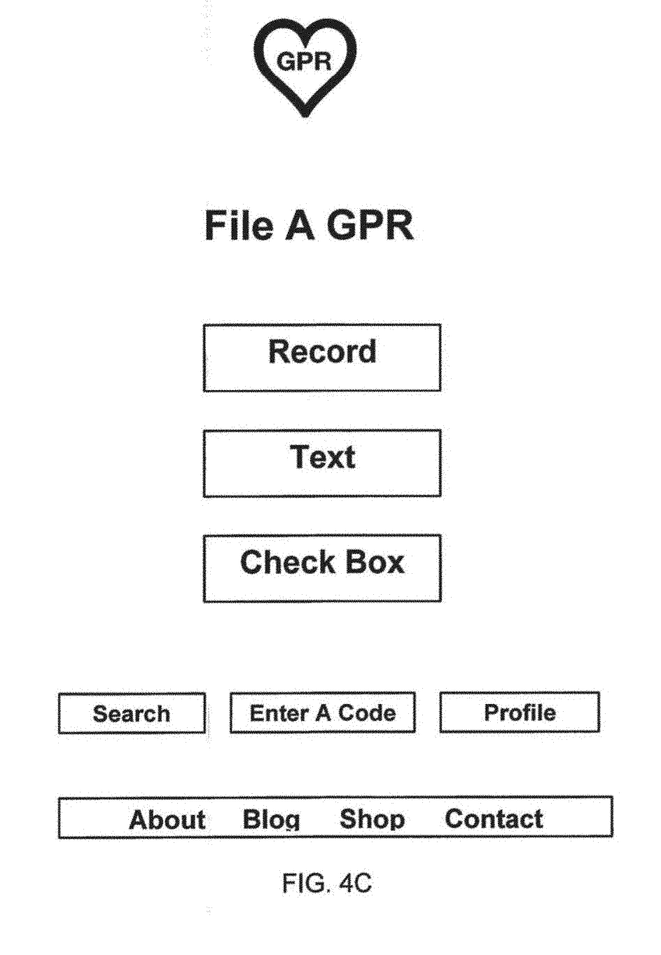

Once registered as a member, the member may have access to a number of features via, for example, a home page as illustrated in FIGS. 3B, 4A, and 4B. The home page may provide information such as recent news, recent updates (e.g. Twitter® tweets), and the ability to enter a code, file a report, or search a database.

A member may be assigned a unique personal code (and/or bar code) that is used to identify the member's account on, for example, business cards, name tags, and email signatures. The unique personal code may be automatically generated by the system in order to ensure uniqueness of the code and in order to maintain the connection between the code and the member. The member may also choose to install a mobile app to access the social scoring system on their mobile devices, e.g., via the iTunes® or Google Play® store. The member may also file reports (or “GPRs”) on people, places, products, or play (e.g., entertainment such as media, books, music, movies). The member may also search a database to see or listen to reports that have been filed on items matching their search criteria. Links may be provided to the member's score to be shown on other social networks such as Facebook®, Twitter®, LinkedIn®, Yelp®, Angie's List®, and Match.com. The member may share his or her profile page with other users, e.g., via a publicly accessible link, and can also share any reports that he or she has filed (e.g., through direct connections with other social networks or by providing a direct link to the report in question).

In some embodiments of the present invention, certain features may be reserved for different categories of members (e.g., paid premium members), as controlled by the permissions module of the system. One such additional feature may be the ability to enable or disable visibility of the account in search results. Another additional feature may be to receive rewards for reaching various levels of overall score, where the rewards may be, for example, discounts on products or services, gifts of products or services, and invitations to events with other high scoring members.

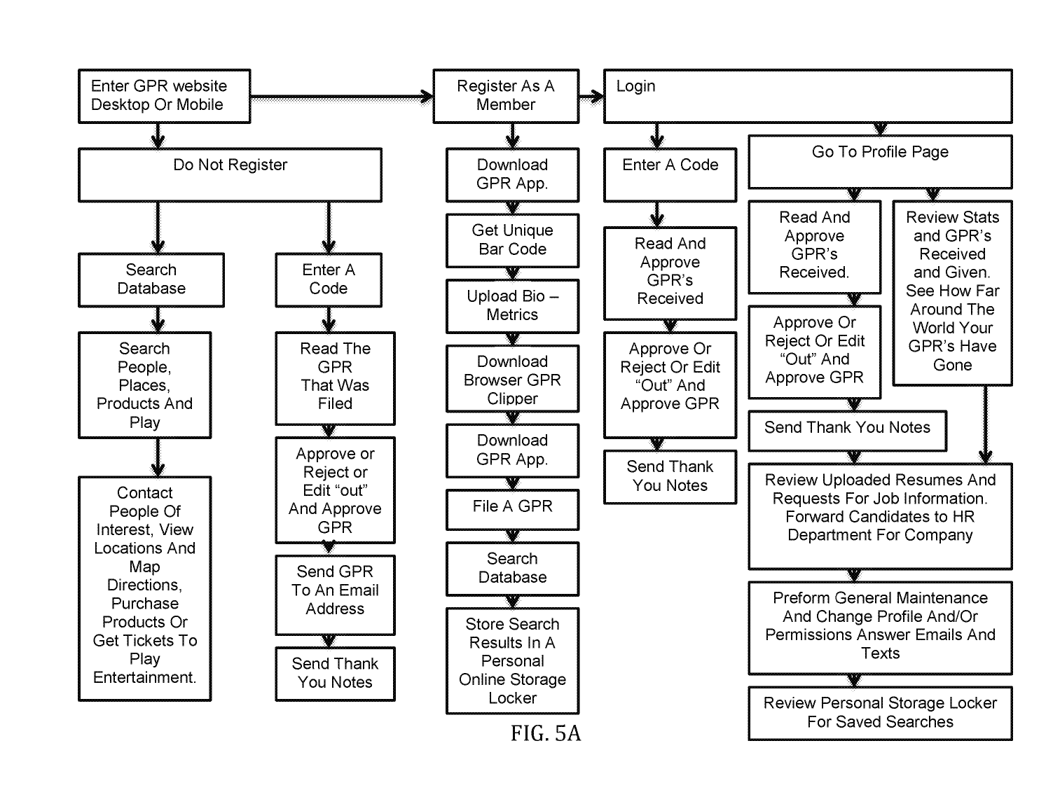

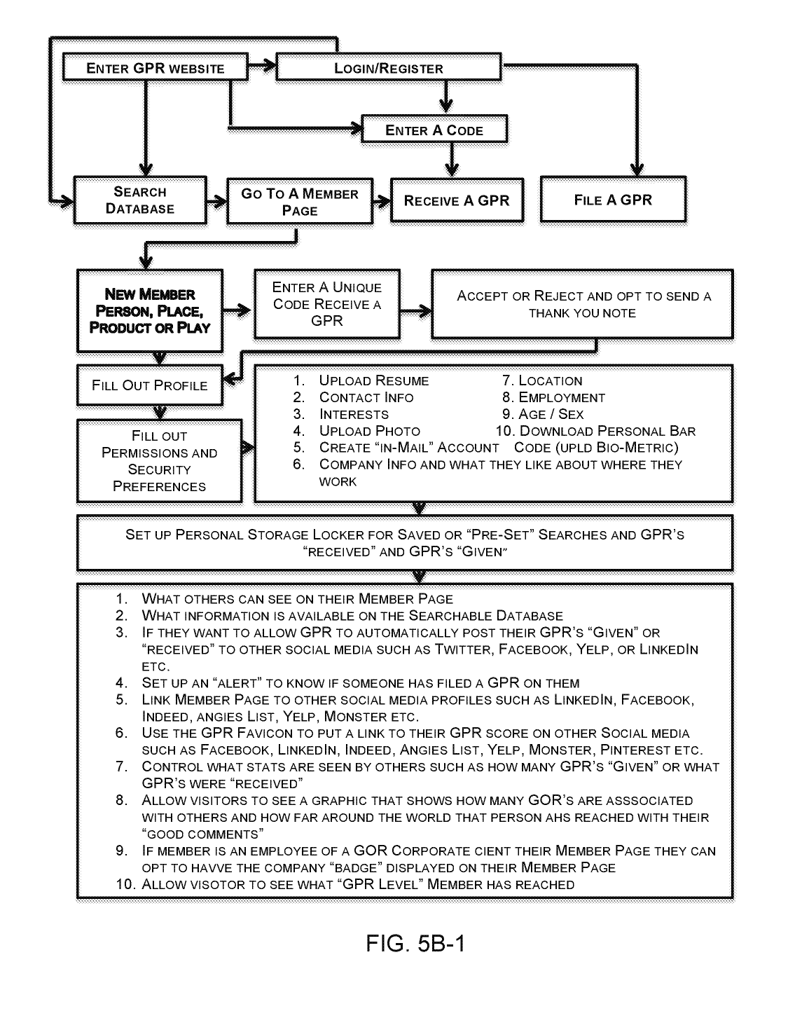

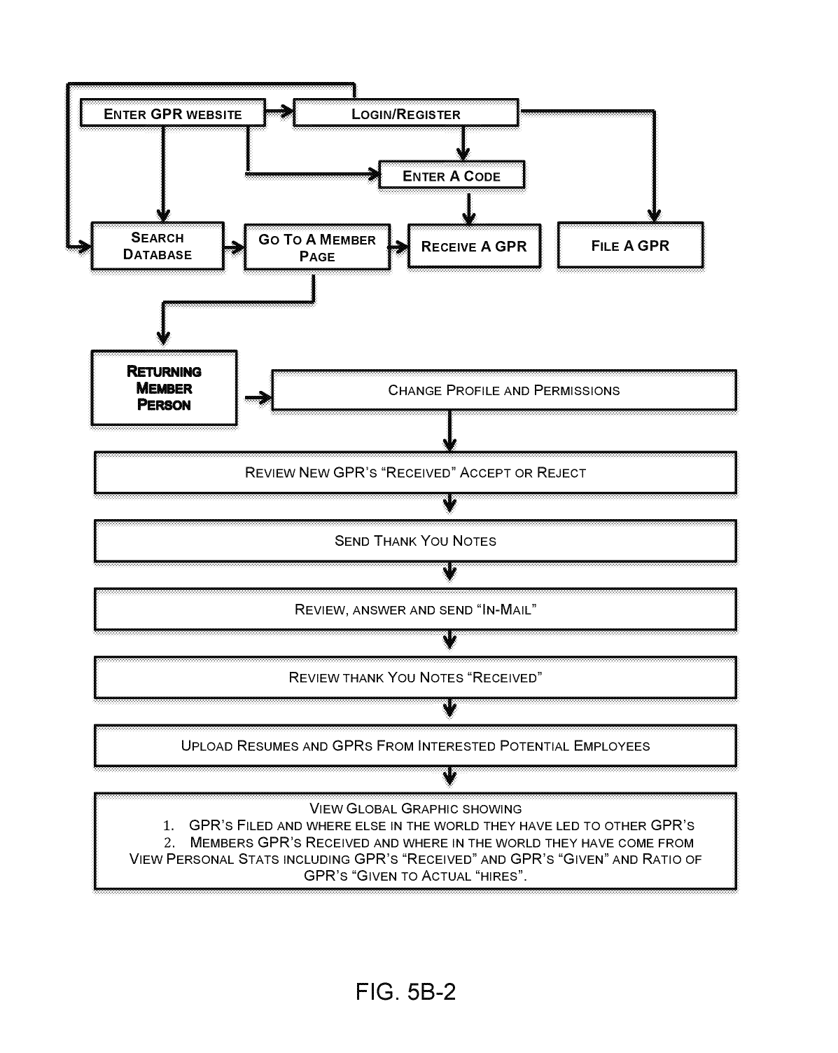

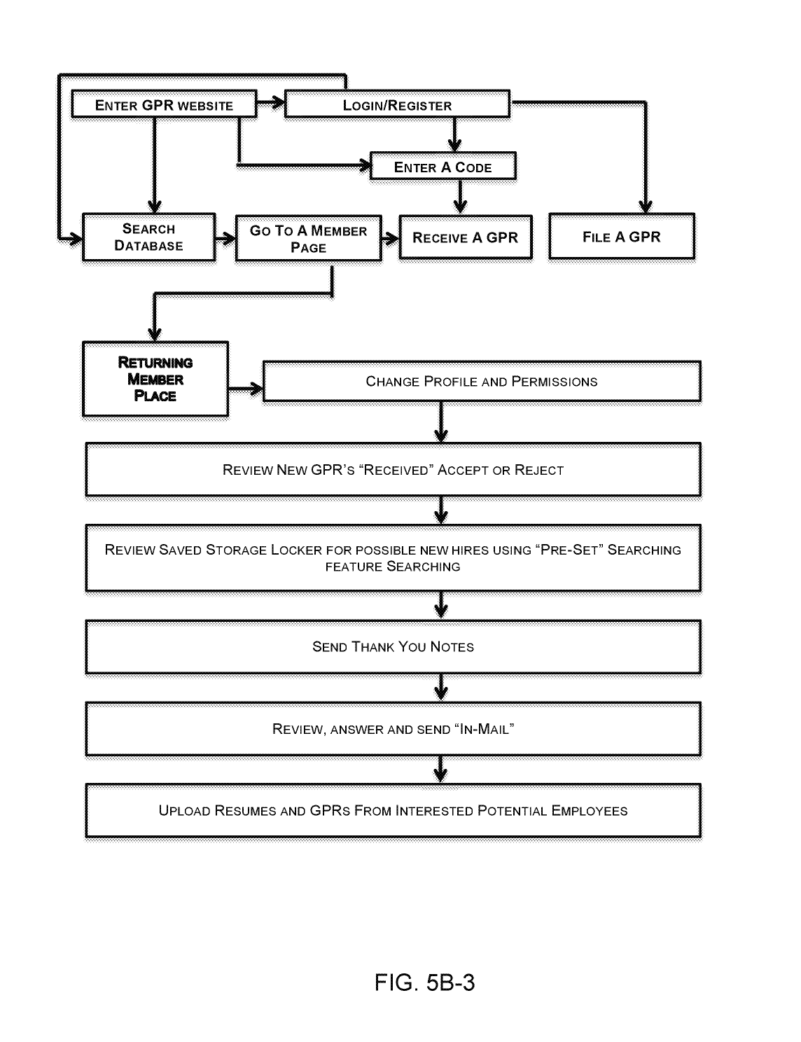

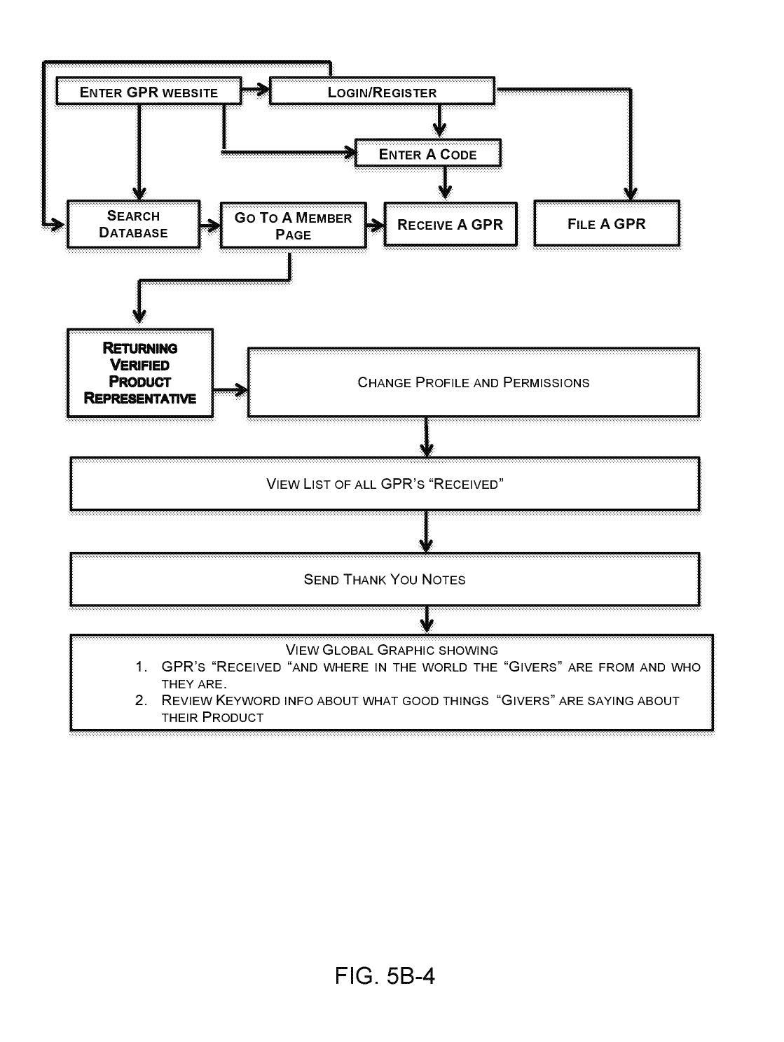

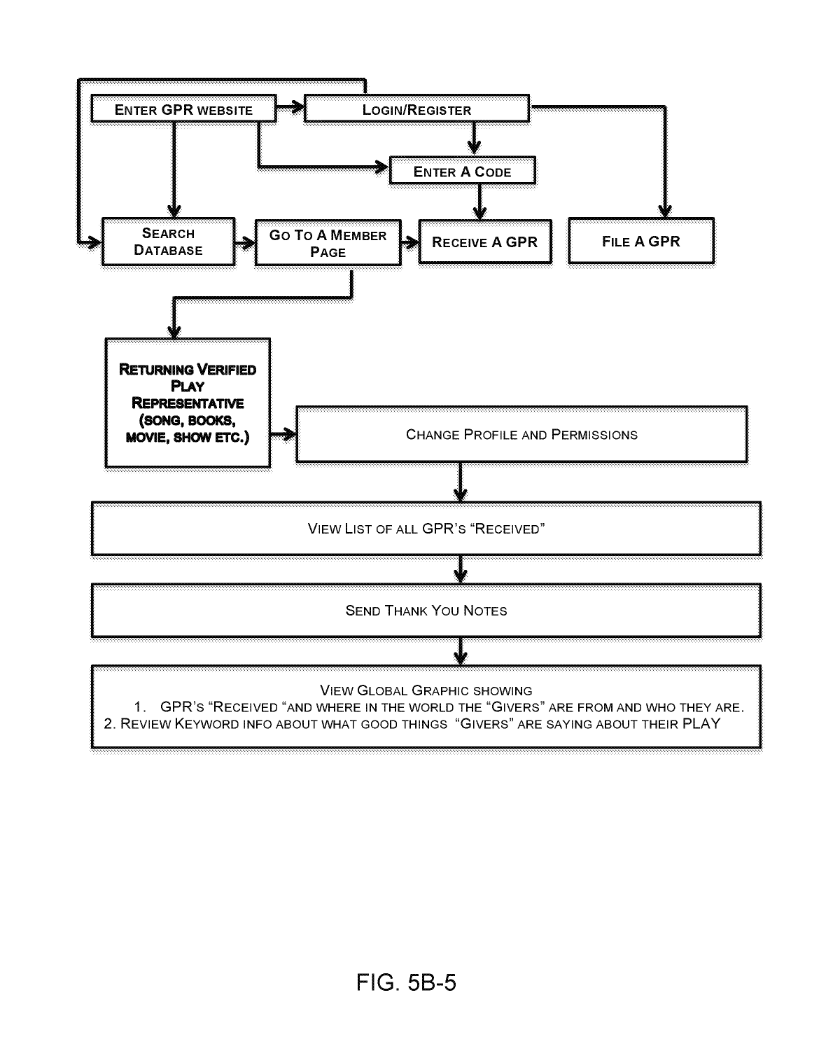

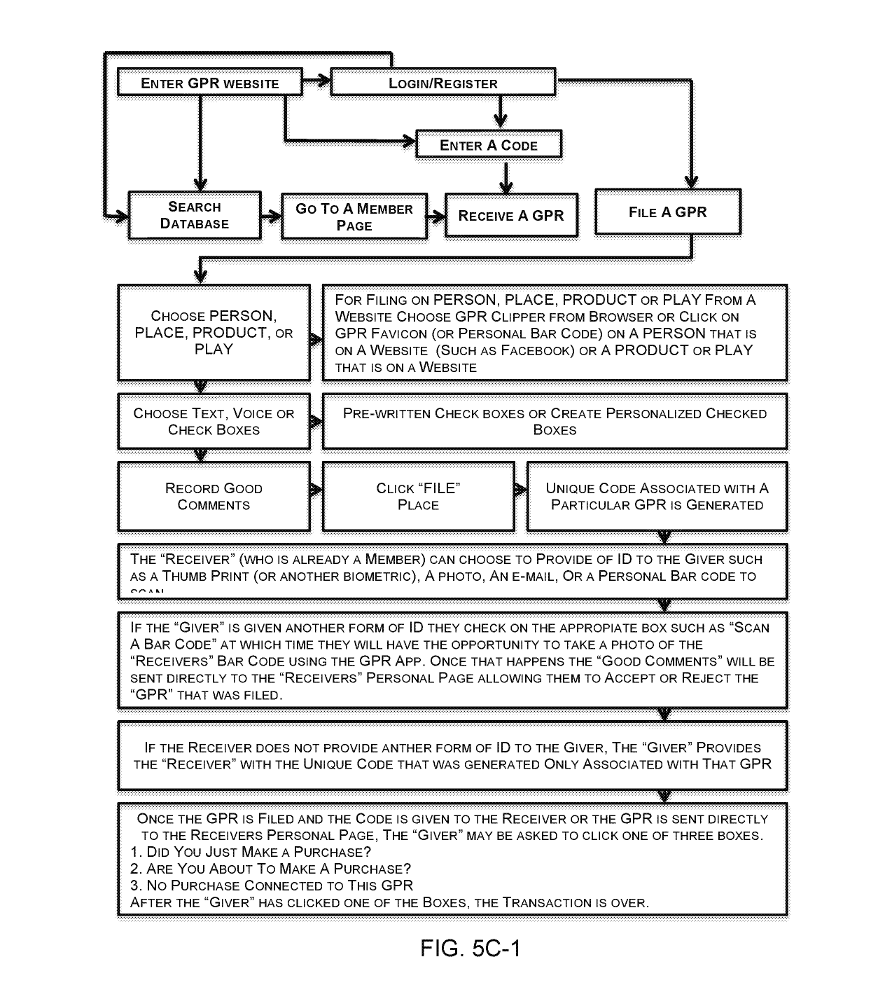

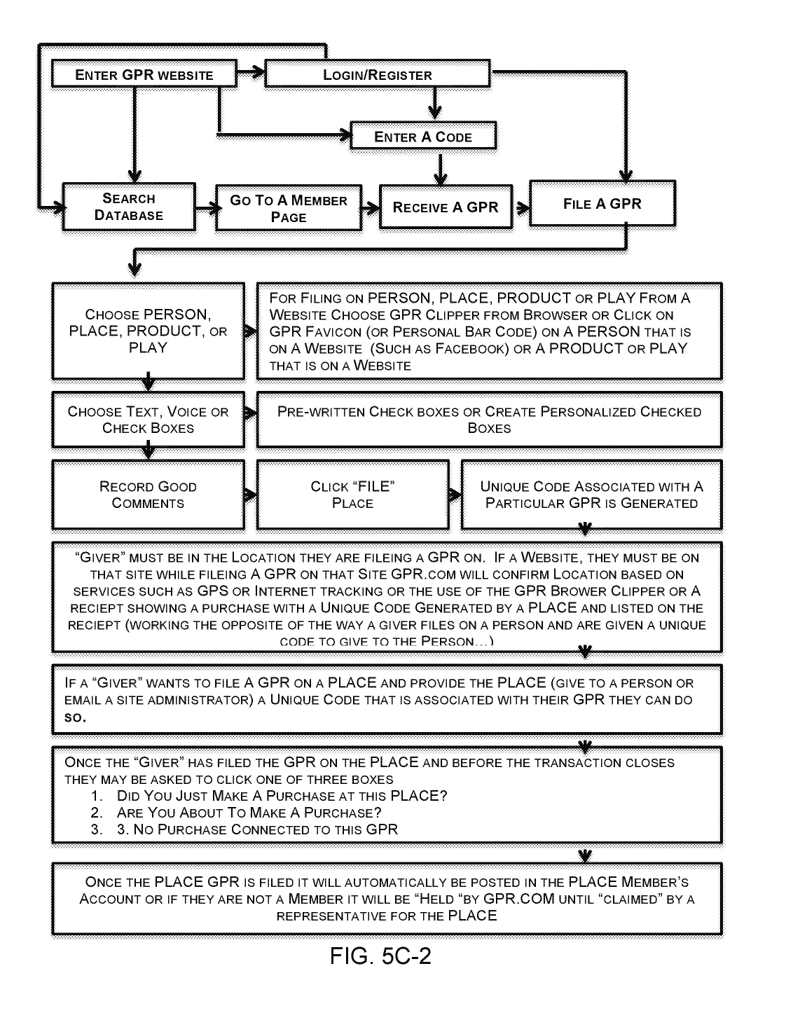

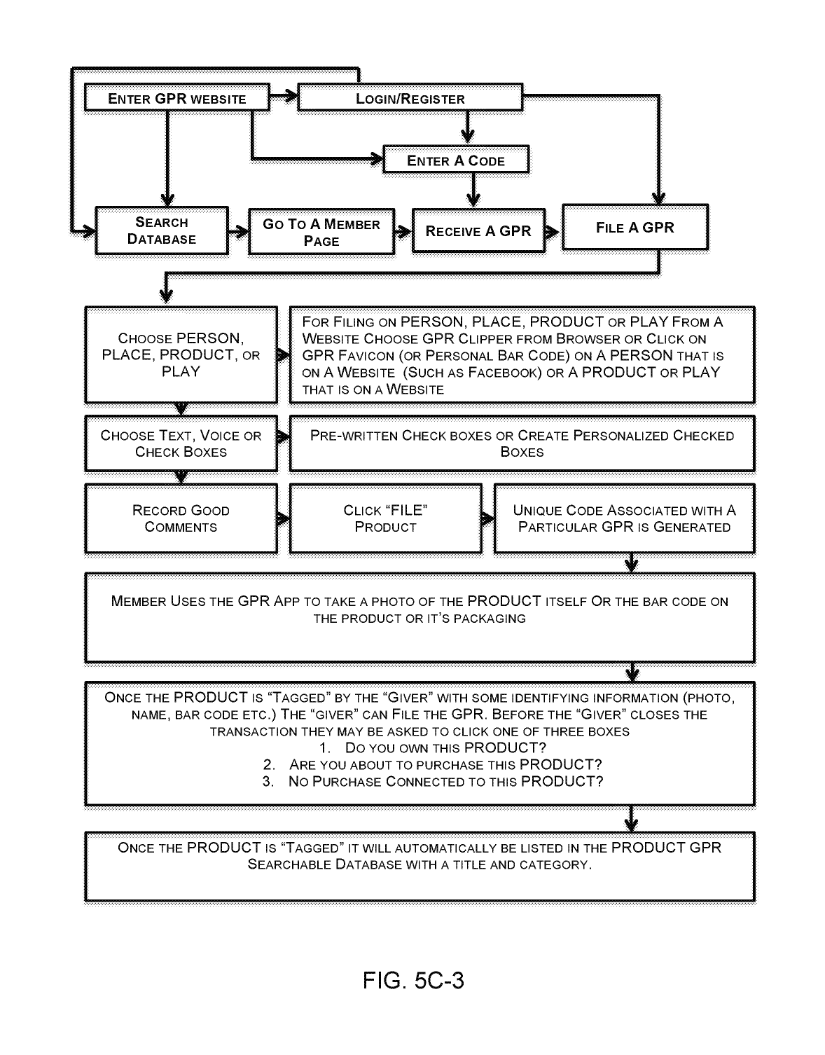

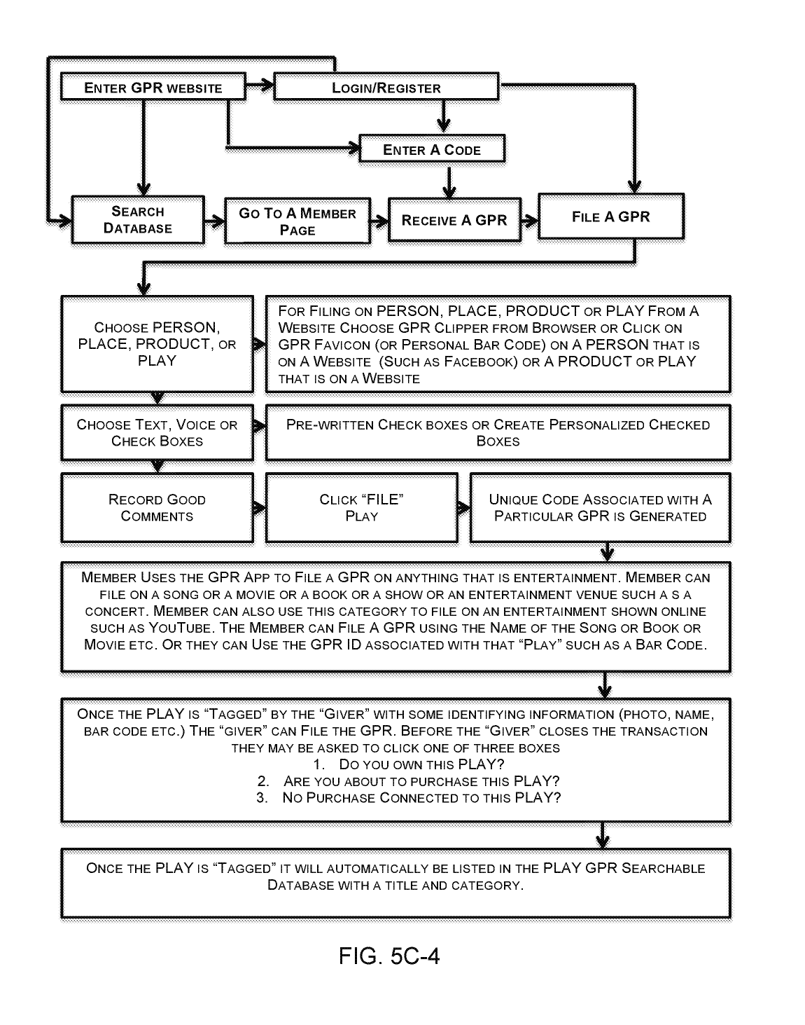

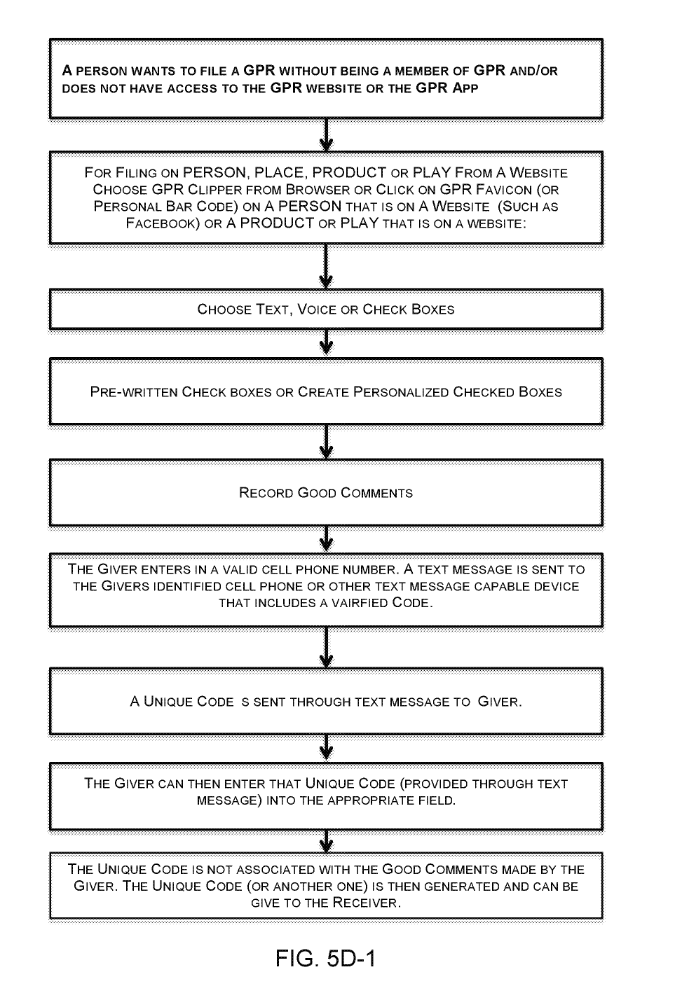

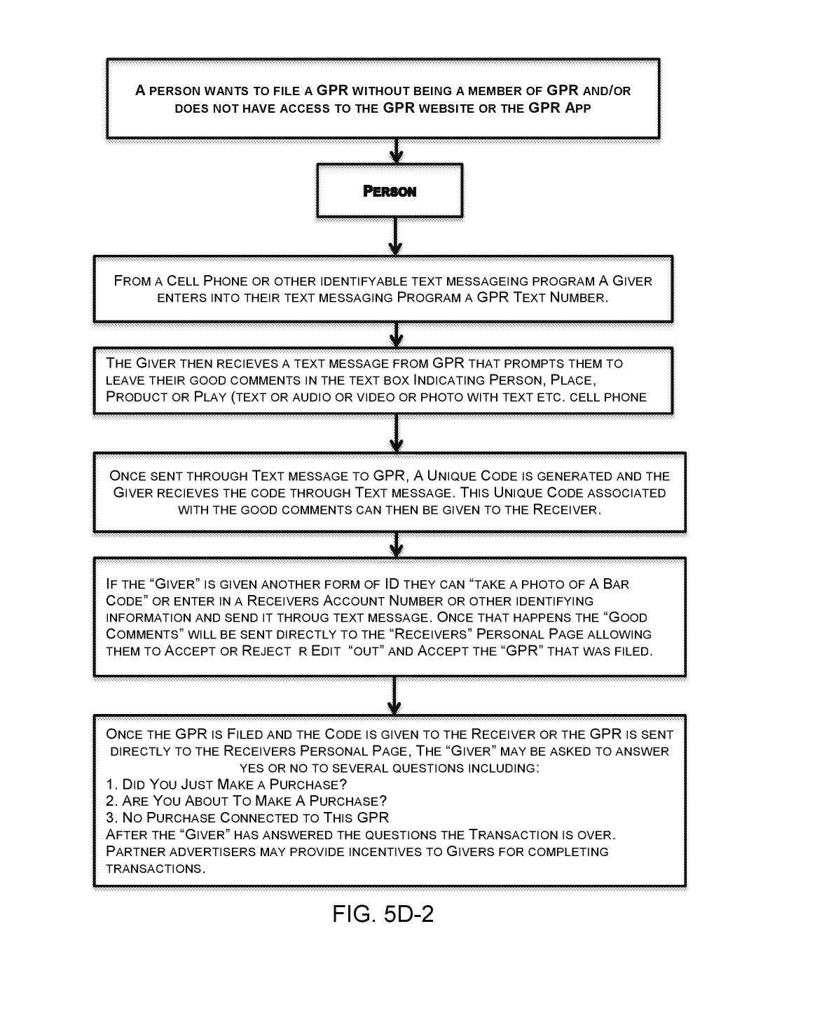

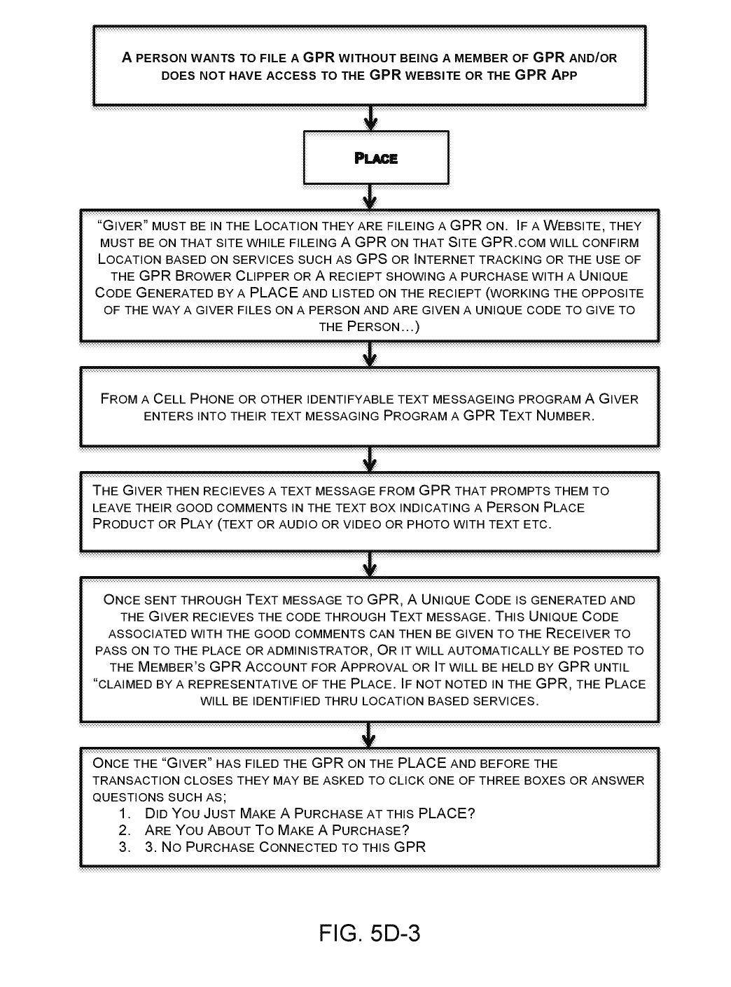

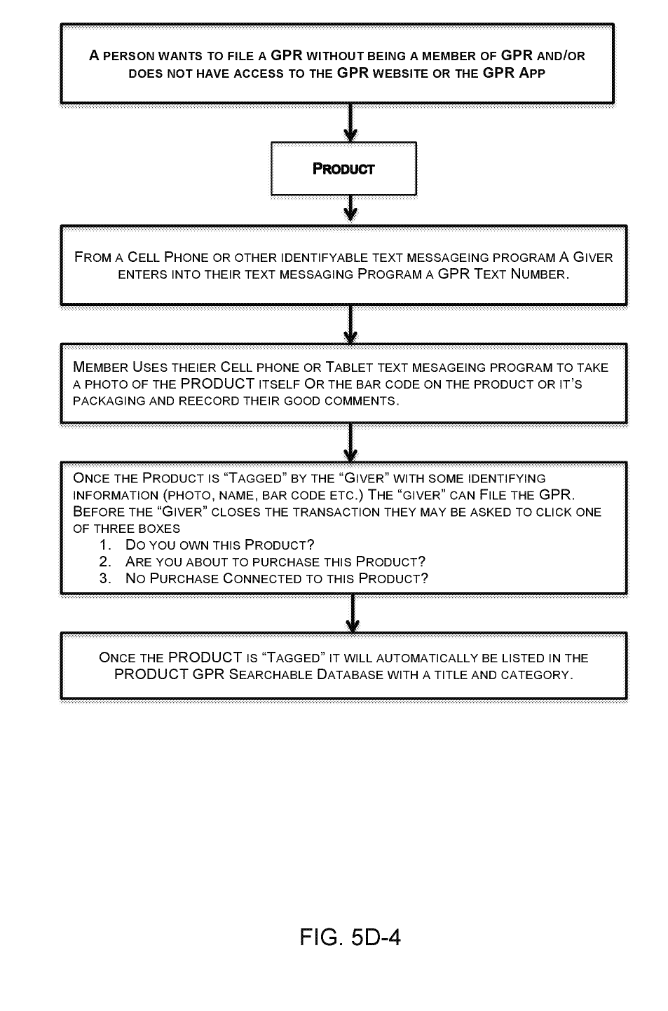

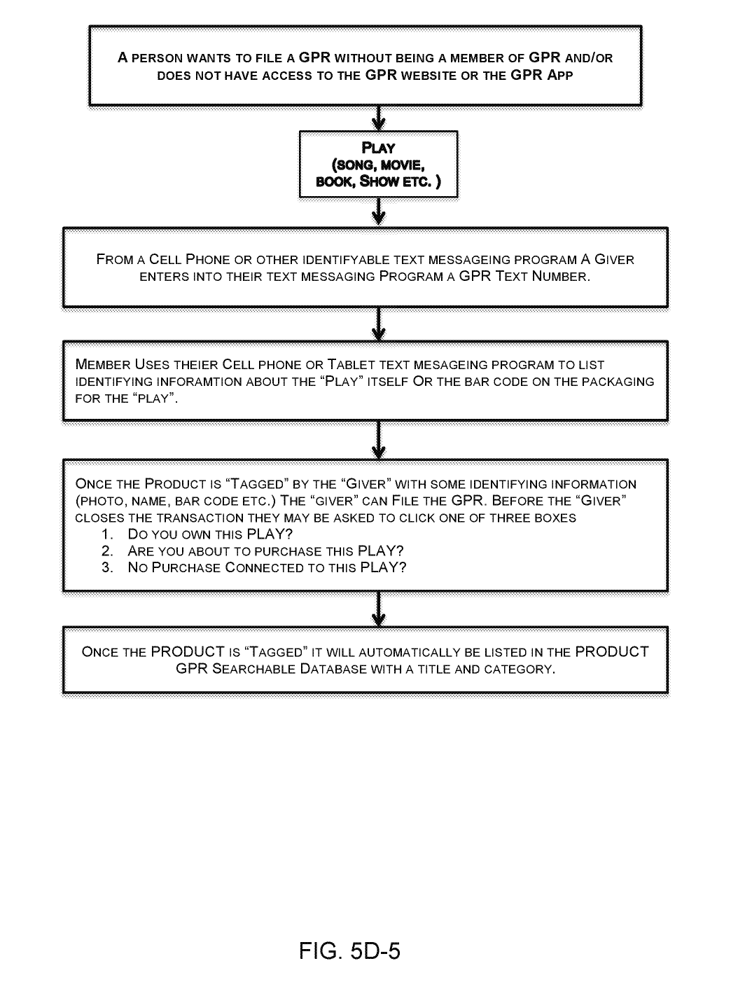

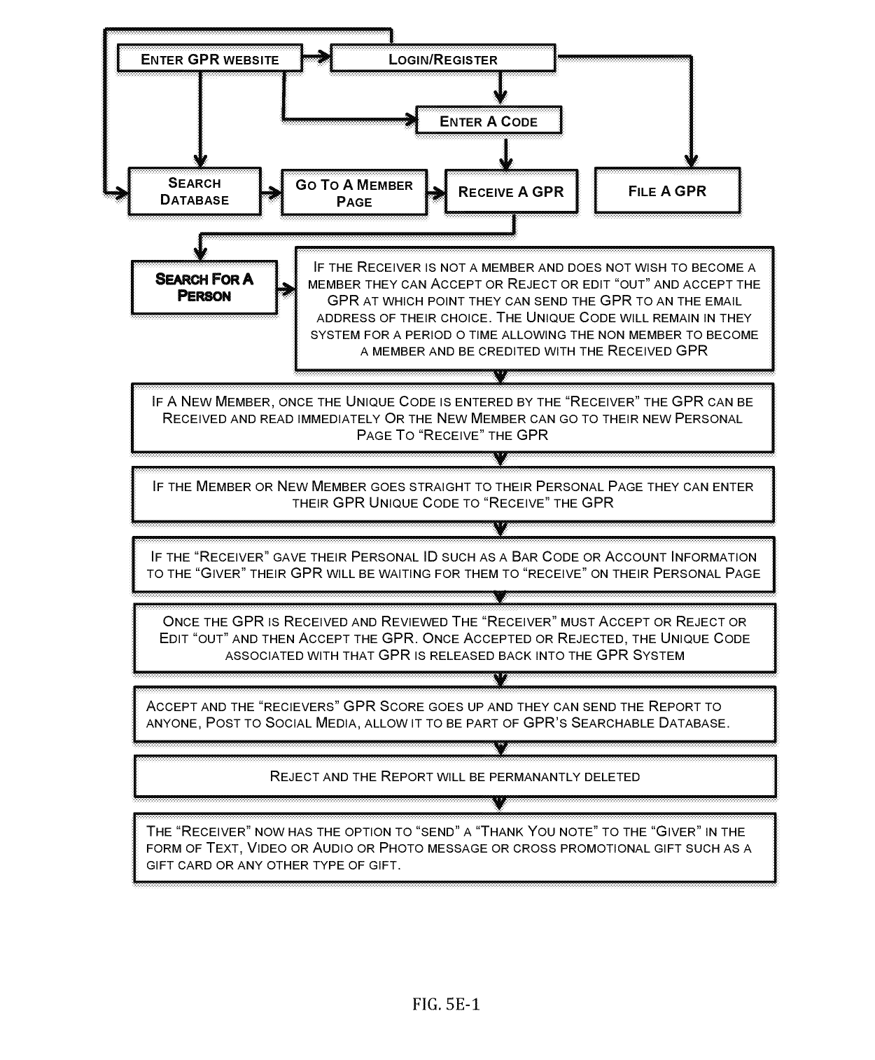

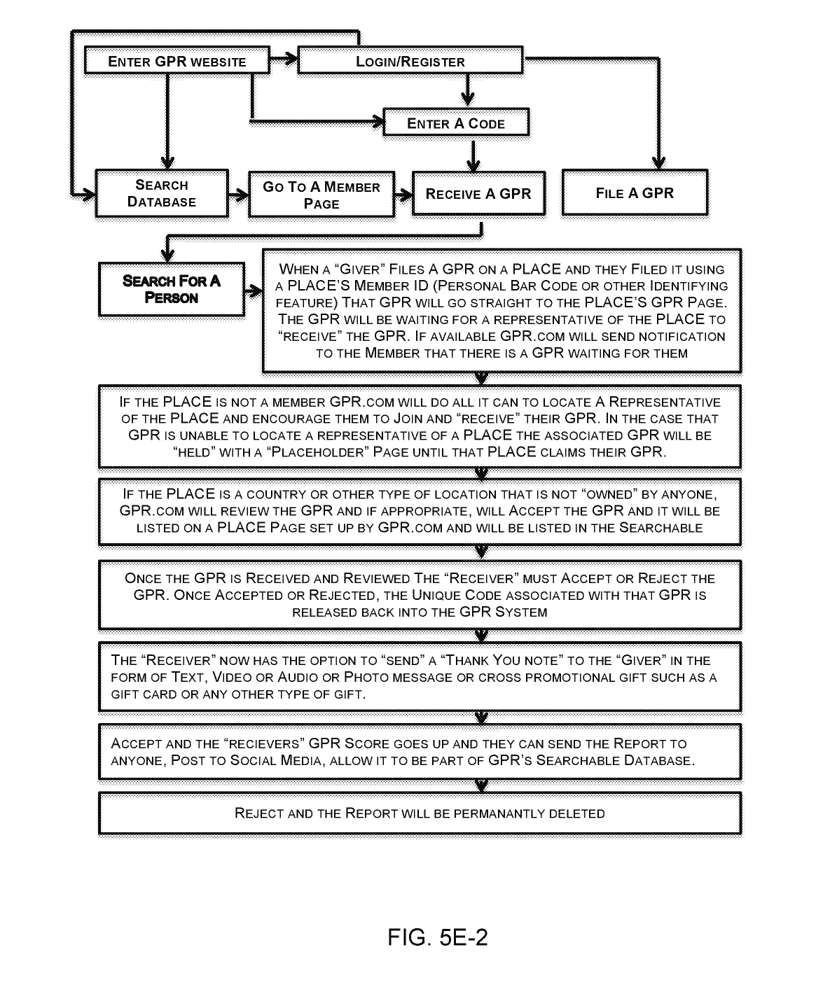

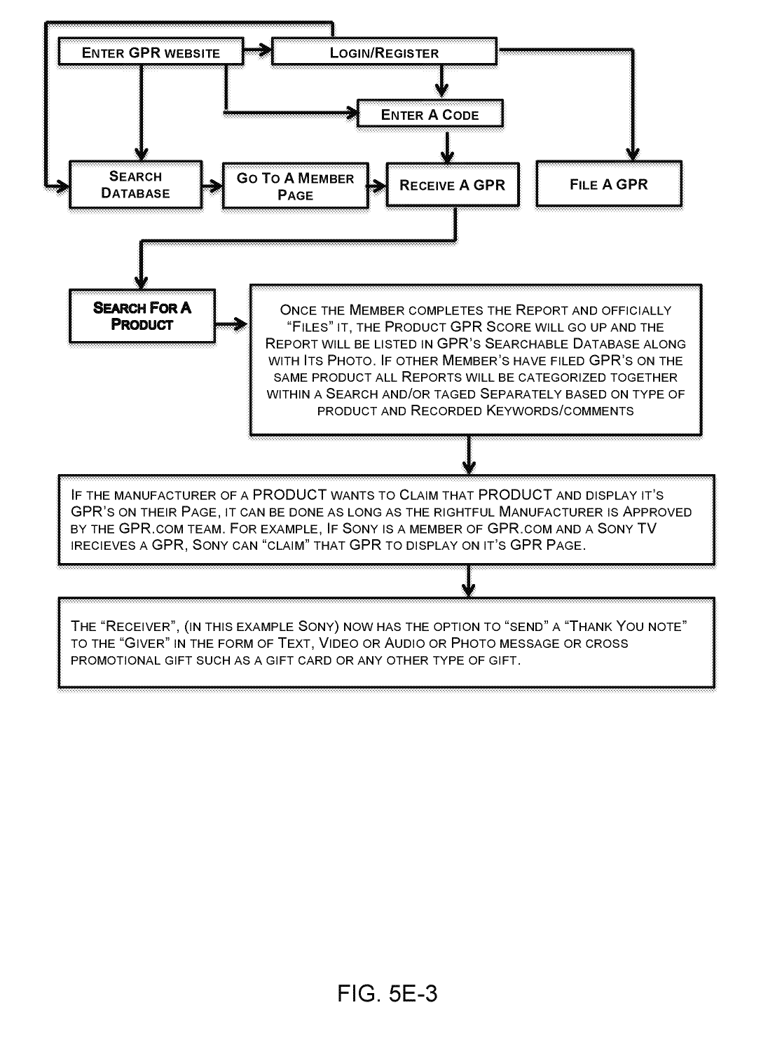

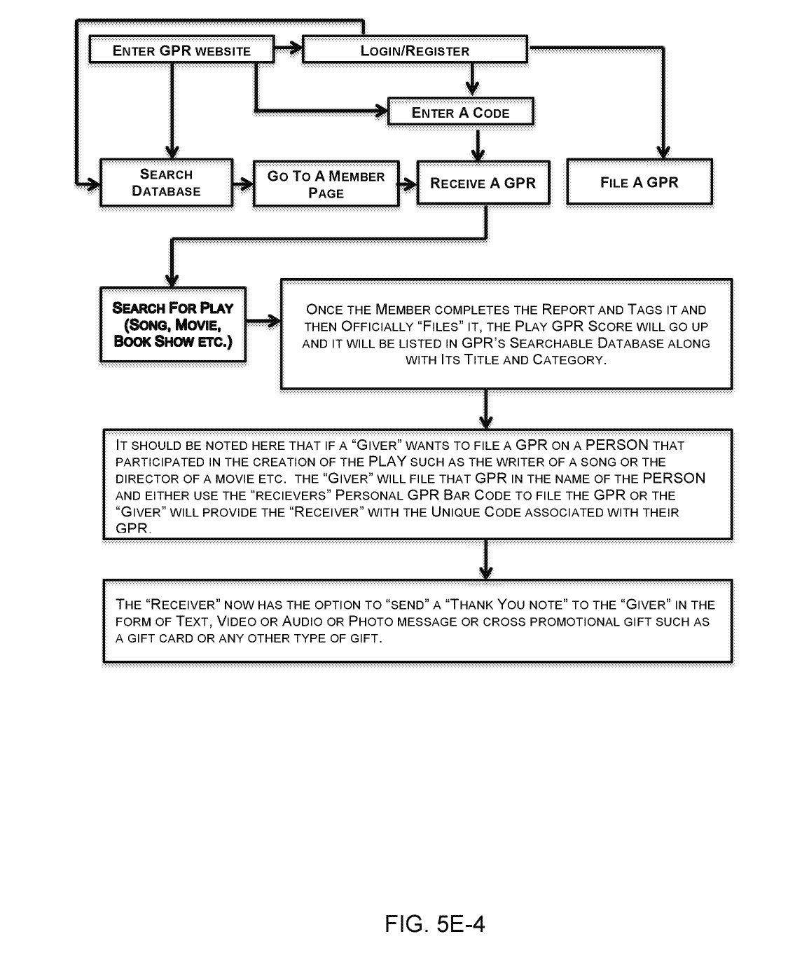

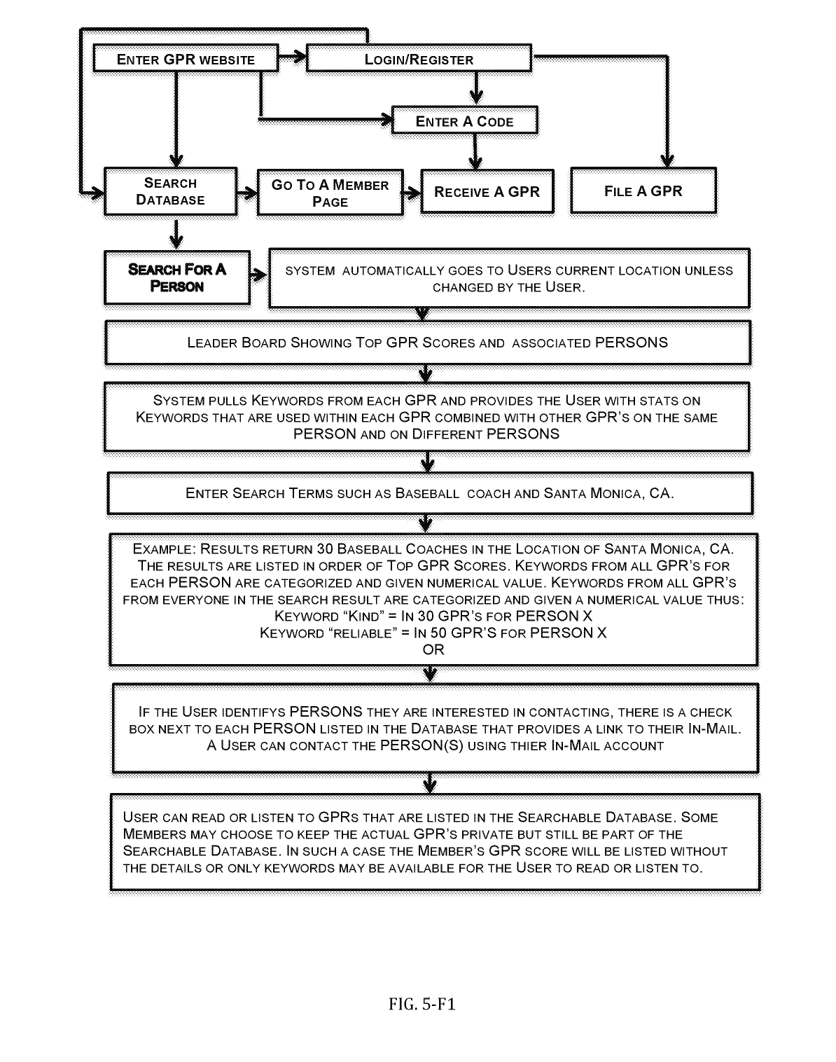

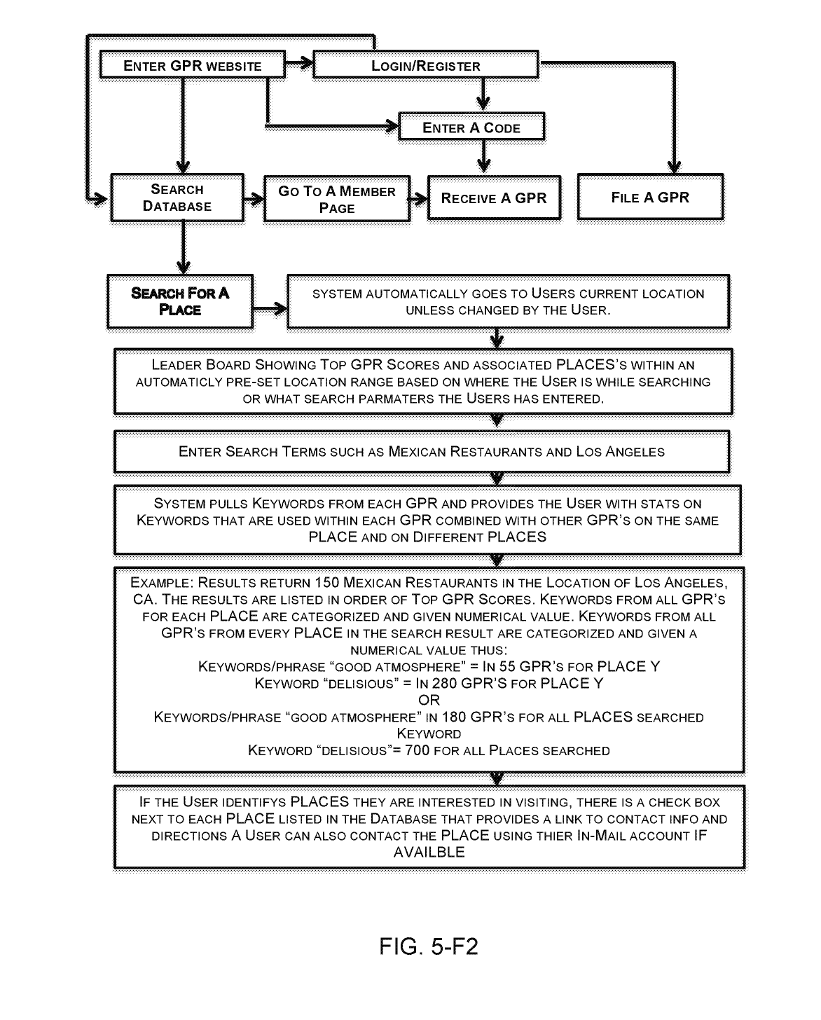

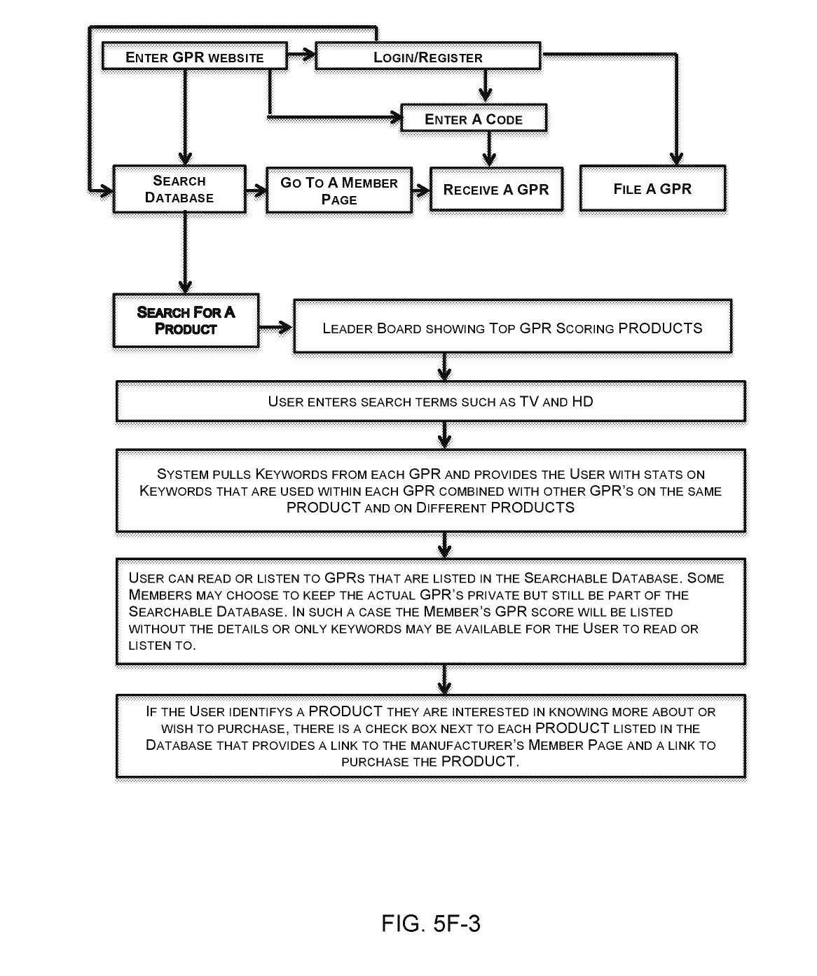

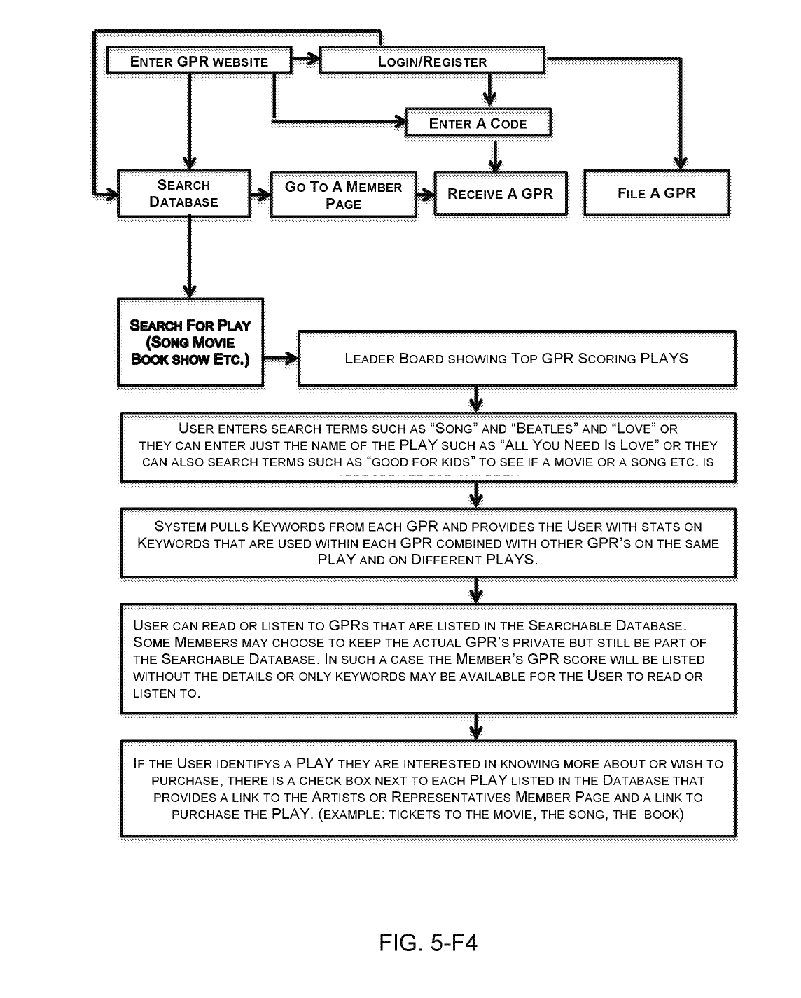

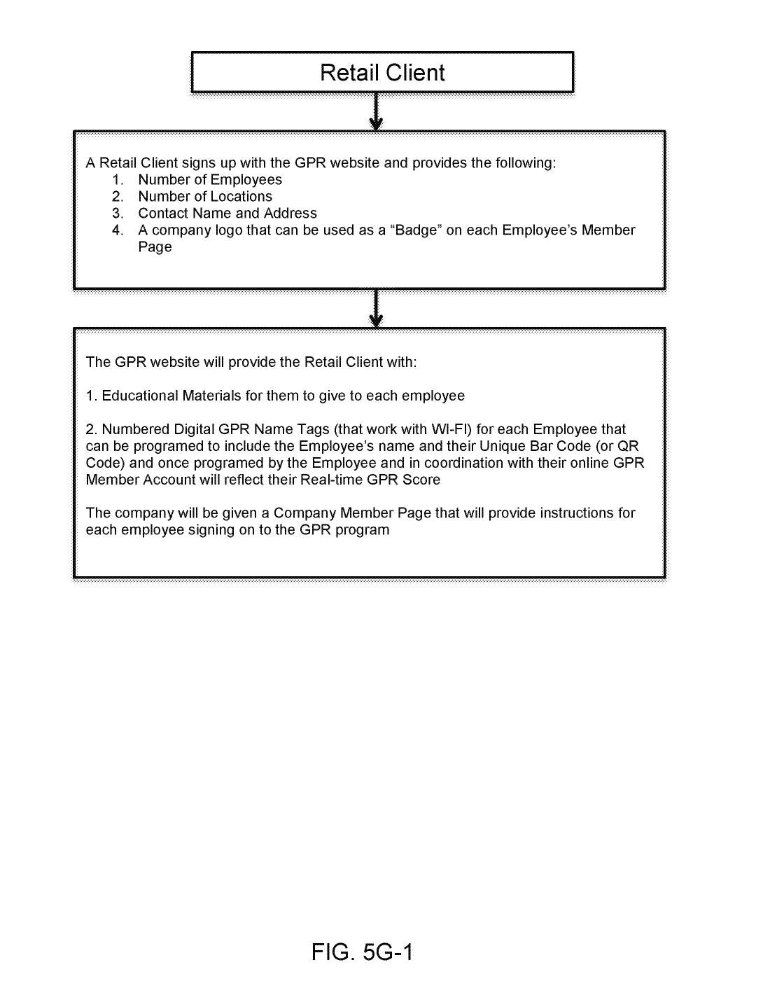

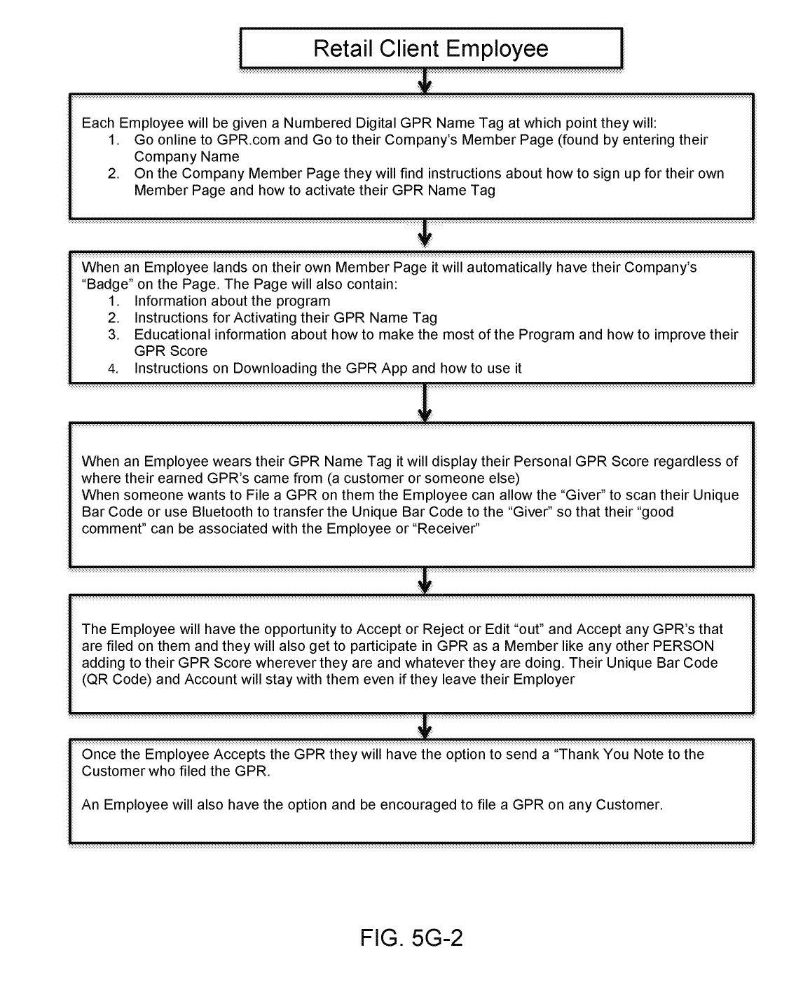

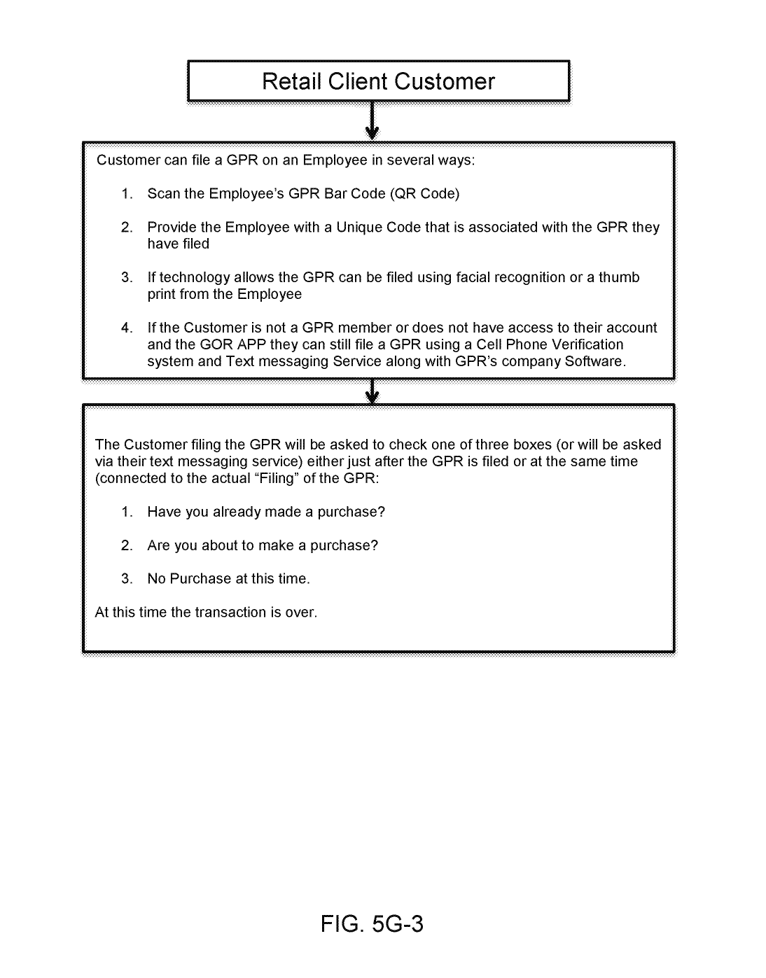

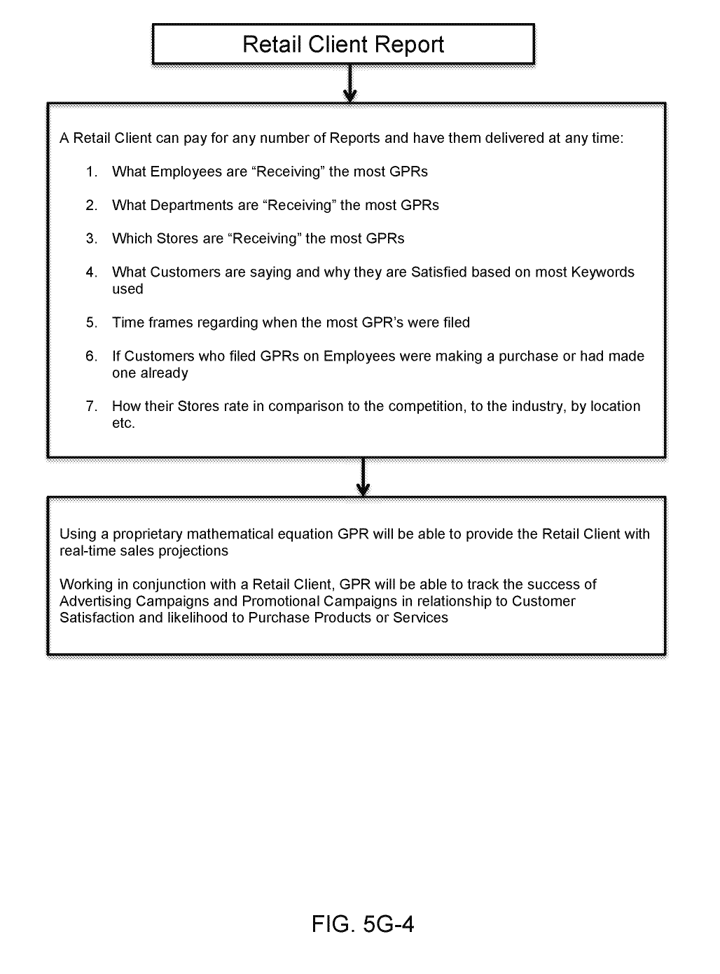

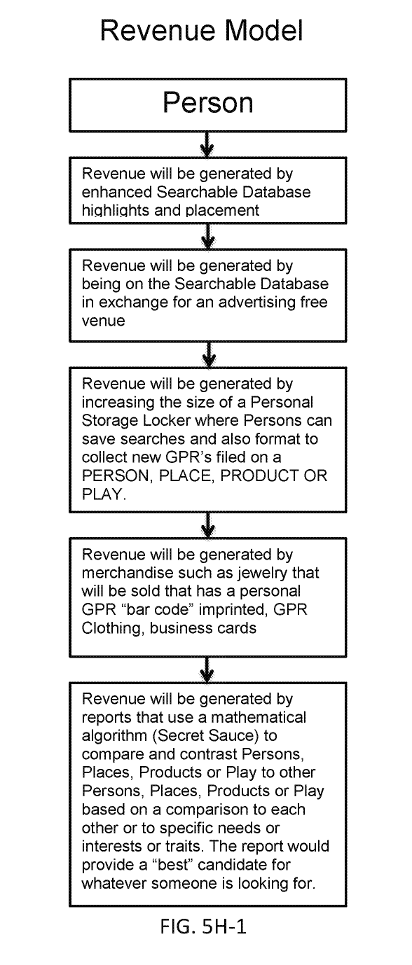

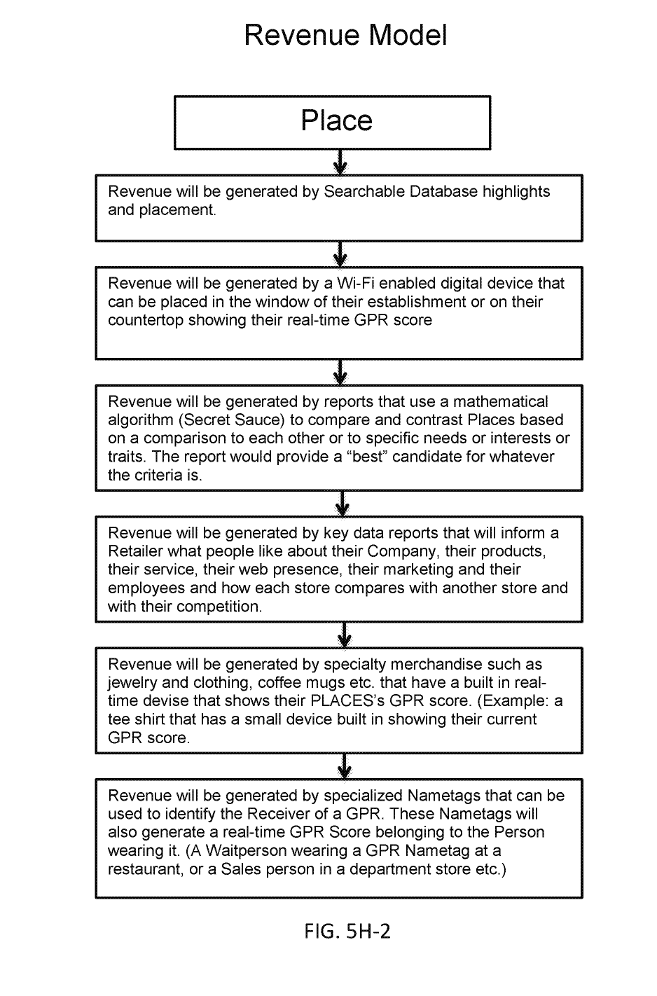

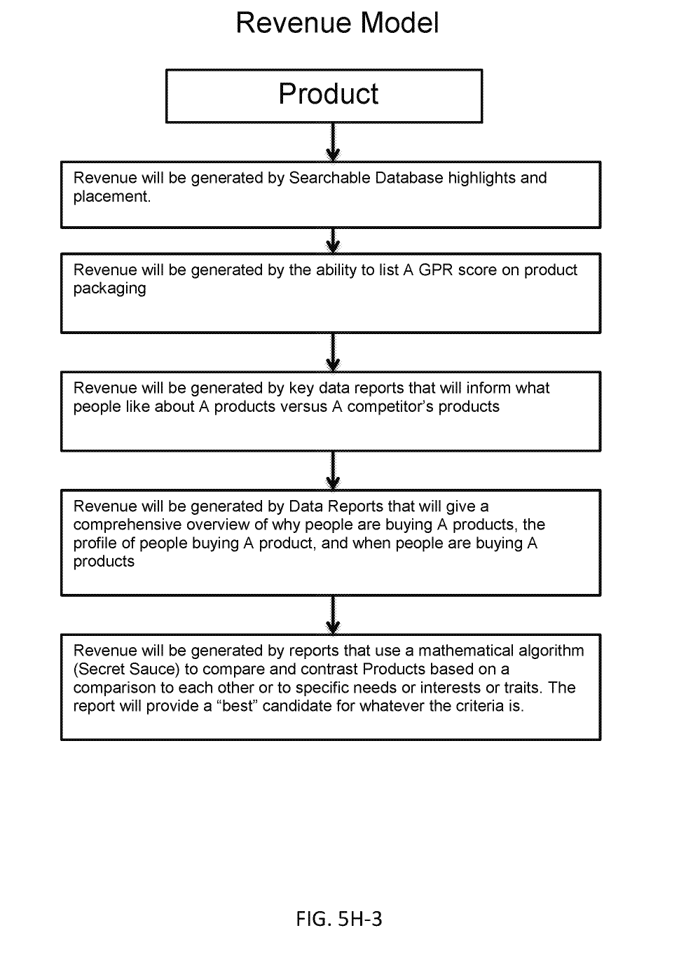

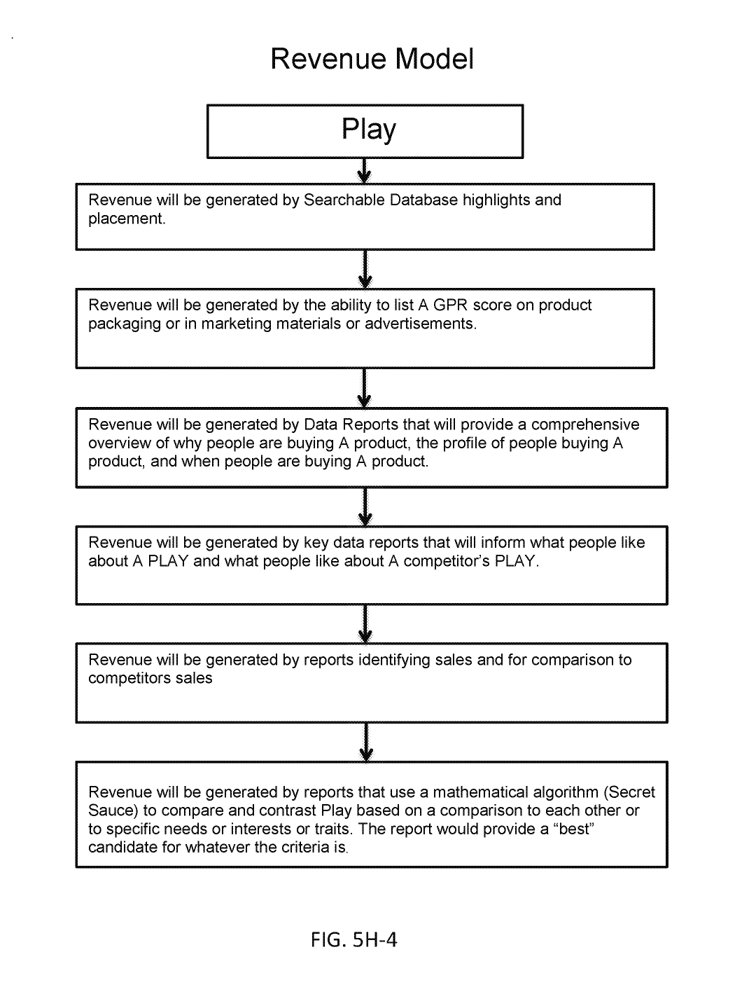

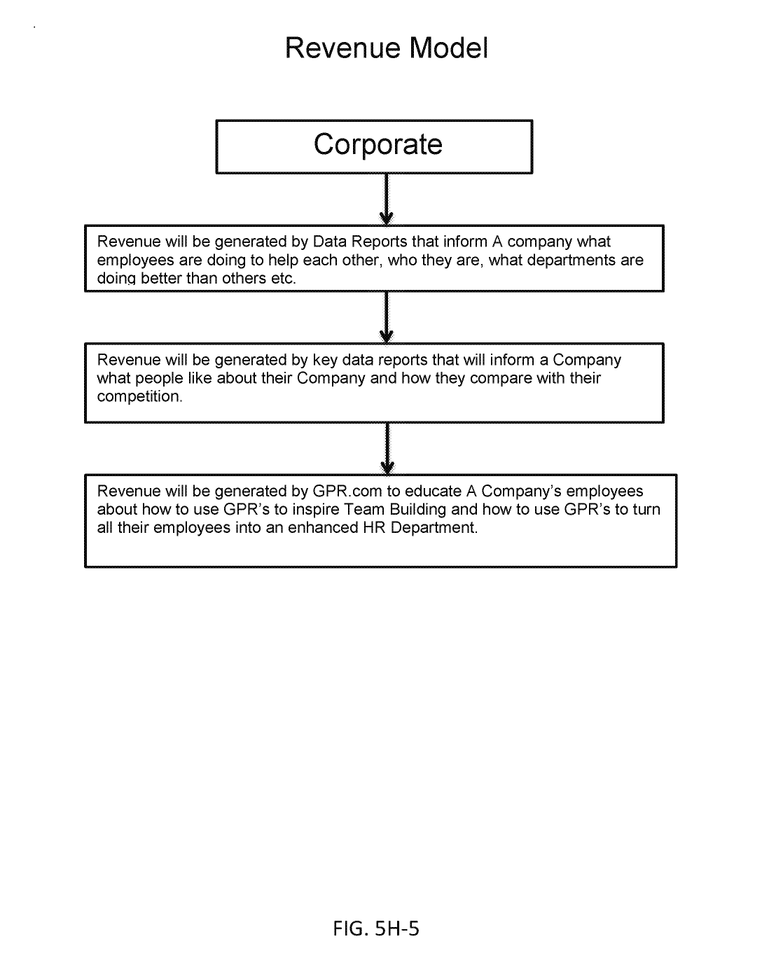

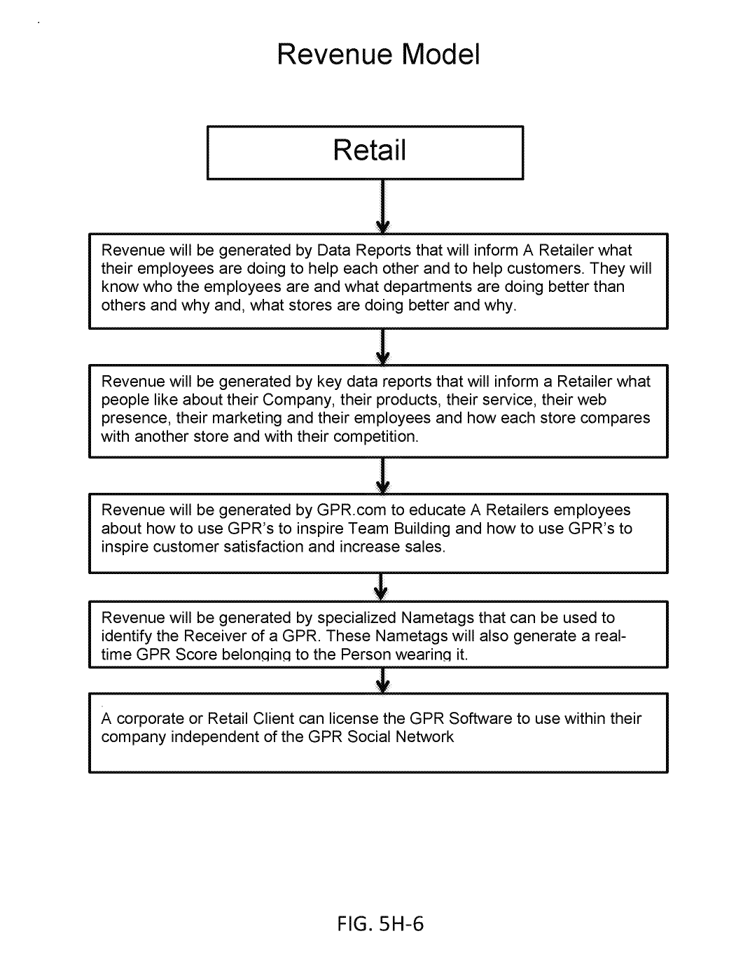

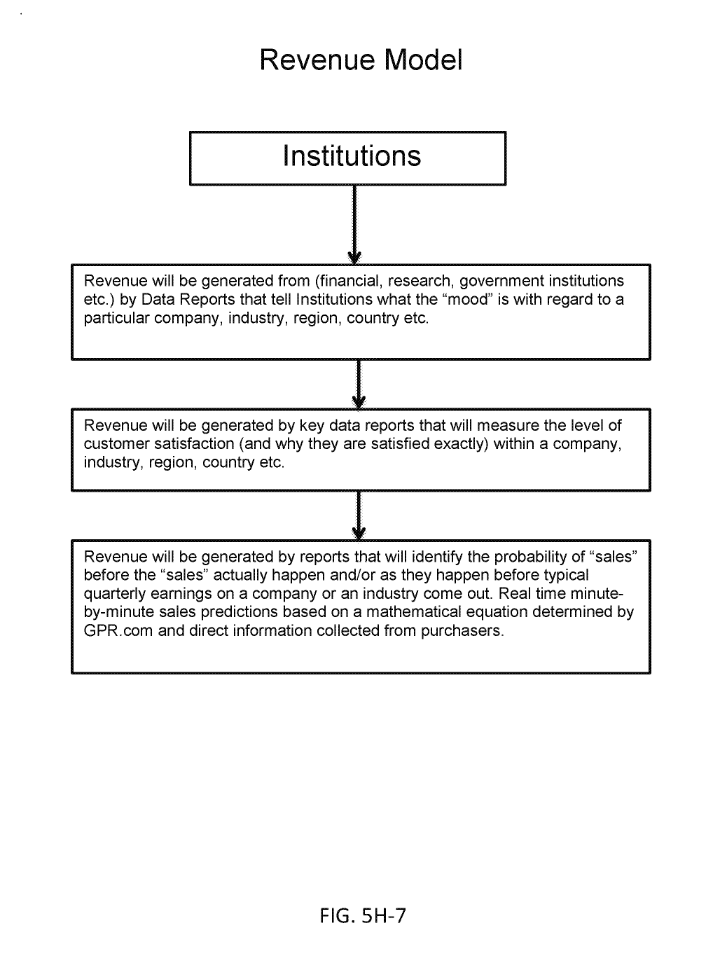

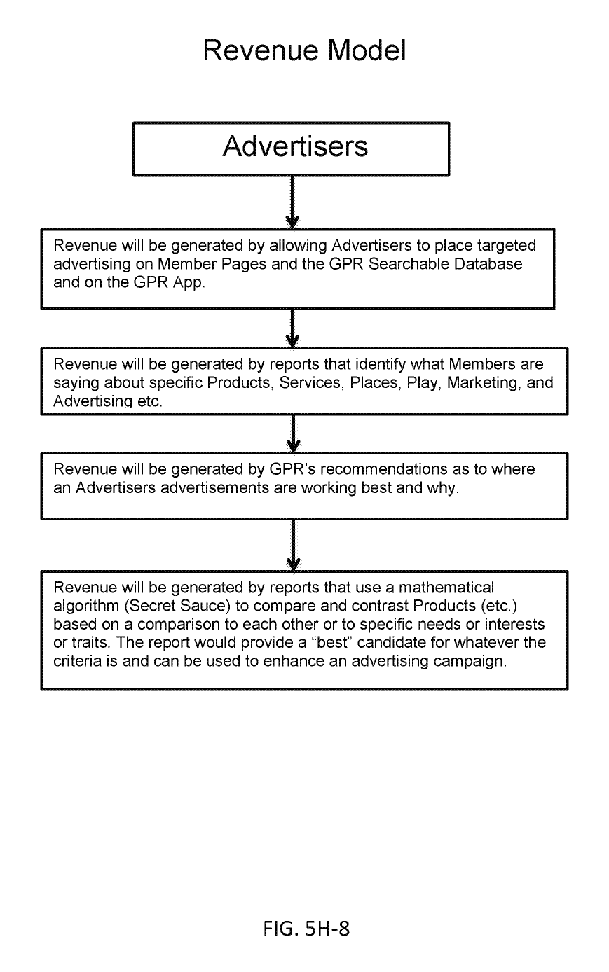

Once the member has signed up, they can fill out a profile page with information such as: address, work history, and an uploaded resume (see, e.g., FIGS. 3C and 5B). A member may also provide information about their current and previous employers (e.g., for others to read about those employers). The members may also provide links to their profiles on other social networking sites such as Facebook®, LinkedIn®, Twitter®, Pinterest®, Monster®, Angie's List®, Yelp®, and Indeed®. Conversely, the members may be provided with an embeddable link from other web pages (e.g., profile pages on other social networking sites) back to the profile page on a social scoring system according to one embodiment of the present invention.

A member may also modify privacy settings and permissions. These settings may include controlling: what others can see on the profile page; what information is available in the searchable database; and whether they want to allow the system to automatically post the reports that the member writes and receives to other social media networks such as Yelp®, Twitter®, Facebook®, and LinkedIn®. The settings may also allow the member to set alerts to let them know when another user has filed a report on the member. Such alerts may be delivered as, for example, a text message, an email, a telephone call, a Facebook® message, a Twitter® message, and a LinkedIn® message.

Embodiments of the present invention may also allow a user to control the types of and level of detail of statistics about the member that are visible on the profile page. The statistics may include the number of reports written by the member, the number of reports received by the member, and the ratio between people recommended for a job by the member and the number of those people who eventually found a job based on that recommendation. Embodiments of the present invention may also allow a member to control whether or not the profile page includes a graph showing how many reports are associated with others and how far around the world the member has reached with his or her reports. If the member is an employee of a corporate member, the member's profile page may include a “badge” that represents the company providing the account. This badge may be seen by others on an opt-in basis.

### Filing Reports (on People)

The downloadable app discussed above or another interface such as a website may be used to create and submit a report (or “GPR”), as shown, for example, in FIGS. 3D, 3E, 4C, and 5C. After logging into their account, a member may choose to file a GPR on, for example, a person, place, product, or play (or media). Once a member identifies which category they wish to file a GPR for by selecting a corresponding button, they may choose to create the GPR through a number of different mechanisms (some of which are illustrated in FIGS. 3D and 3E) or combinations thereof. For example, the GPR may be created by recording spoken comments using a video camera and/or a microphone of the device (e.g., the microphone of a mobile phone or of a laptop or desktop computer), by typing in text comments, emoji (or other symbols expressing emotions), by sending a photo or series of images, by sending licensed music or video (e.g., portion of a feature film), by sending music and/or video developed for use with the social system, and/or by selecting from a multiple choice list of options (which can be edited or expanded upon by a user). Once comments are logged, a member may then press a button to “file” the report and to generate a corresponding unique code (or report code) 202 that is associated with the report.

The Giver (or reviewer) can provide the Receiver (or reviewed user) with the report in one of several ways including: writing down the report code, telling the reviewed user the report code, emailing the report code to the Receiver (from an email address provided by the Receiver), taking the Receiver's biometric data (e.g., a thumbprint or retinal scan facial recognition) with the report code for matching against stored fingerprints or for when the Receiver may later sign up with the social scoring system, scanning (e.g., with a camera of the mobile device) the Receiver's personal code (e.g., on a business card or nametag), or through a Bluetooth connection (e.g., between the Receiver's mobile phone and the Giver's mobile phone). In some embodiments, the report may include information about whether the report Giver is about to make a purchase or has just completed a purchase. This information may be based on information registered with the system such as cell phone number, password, signature, photo, breath analysis, RED identification (e.g., integrated into a smartphone), facial recognition, or other information passed from one device (e.g., smartphone) over a local communication system such as near field communication (NFC) or Bluetooth.

FIG. 5D is a flowchart illustrating a method for filing a report (or “GPR”) according to one embodiment of the present invention by a non-member or while the Giver is not signed in to the system. The method for a filing a report while not signed in is similar to that shown in FIG. SC for filing a report while signed in and further includes operations for verifying the Giver using. A Giver can give a GPR without being a member by providing a verifying cell phone number with text verification (or other identifying biometric code) to prevent someone from repeatedly giving GPR's to the same person without controls. Utilizing a text message system the Giver can give a GPR by entering in their cell phone number into another device, such as a tablet at a kiosk, or using their phone directly to text a specific number they can file a GPR using text messaging. The kiosk may be owned and operated by an entity different from the retail outlet and therefore may be considered “outside” technology in a “location” with the ability to use it to send a GPR. This kiosk may be used by employees at the retail store and also by a place that has a Kiosk set up at a table or on their counter. This kiosk also allows the Giver the ability to file right through their technologically advanced interactive menu.

Once the GPR is texted back to the given number a Unique Code is generated and can be given to the Receiver. If the Receiver already has an account their “bar code” can be sent as a photo or their account number can be entered (or facial recognition may be used to identify the account). An example might be a customer in a participating department store. If the customer is not currently a member but wishes to acknowledge the sales clerk with a GPR, this method allows the report to be filed on the fly using a cell phone and can accommodate all the standard features in the GPR App without an account and without a separate application.

### Receiving Reports

Systems and methods for receiving reports will be described, according to one embodiment of the present invention, with respect to FIGS. 3F and 5E.

Receivers who are not members first sign up with the social scoring system to become members, to set up individual profile pages and, if desired, to have their profile pages added to a searchable database. In addition, non-members can also enter a code and, if the report is accepted, it can be sent via email.

When a Receiver has received a report; the Receiver can claim the report by logging into the system. If the Receiver has a report code, the report code can be entered into the system manually to claim the report to associate that report with the Receiver's account. If the report was automatically associated with the Receiver based on, for example, a scanning of the Receiver's personal code or based on the Receiver's biometric data, then the report may be automatically associated with the Receiver's account.

All of the received reports are displayed in a manner similar to that of an email inbox. The Receiver may read and/or listen to the reports made about them. If the Receiver decides to accept the report, then the approved report is added to the user's profile page and used to compute the Receiver's personal score. In some embodiments, reports that have not yet been approved or that have been disapproved do not appear in the user's profile and, in some embodiments, are not used in computing the user's score. In some embodiments, disapproved reports are deleted.

A Receiver may also share the reports made about him or her on other social networking sites, privately shared to other users (e.g., by email), added to the searchable database, and/or shared with other users of the social scoring system (e.g., other members).

In some embodiments, the Giver of the report may choose whether or not the Receiver is allowed to know the identity of the Giver. As noted above, in some embodiments the Receiver may edit a report by deleting portions prior to making the report readable by other users. In some embodiments, edited reports include a notice to state that they have been edited by the Receiver. In some embodiments of the present invention, the Giver does not need to be a member (e.g., registered user) of the system. For example, a text message (e.g., SMS or similar technology) may be automatically sent to a Giver and receiving a response from the Giver may be used as confirmation of the Giver's identity to allow a Giver to file a report without a membership.

In some embodiments, the Receiver may send the Giver a thank you note. The Receiver may be given the option to send the thank you note when they access the report filed by the Giver. The thank you note may be sent to the Giver via the Giver's account on the system. If the Giver of the report does share his or her identity, then the Receiver may send thank you notes back to the Giver, e.g., in the form of a plain text message, a photograph, audio, video, etc. In some embodiments, when the Giver is anonymous (e.g., sends the report without an account), a thank you note may be sent using the anonymous Giver's email address, phone number (as determined during the confirmation described above), or other messaging system. In addition, embodiments of the present invention may allow the recipient to share his or her resume with the Giver, which may be useful when the report relates to a job opportunity with the Giver or the Giver's company. In addition, a recipient may look at the company “badge” on the Giver's profile to read more about the Giver's company. In some embodiments, the Receiver may send a gift card (e.g., from a sponsor of the system) back to the Giver. In some embodiments, a business may automatically send a Thank You to a Given in response to receiving a report, where the Thank You may include a coupon or other promotion.

In some embodiments, if a Receiver is not a member he can put in his Unique Code received by the Giver and still access the GPR that was filed. Ile will then have the option to join and save the GPR to his account or have it posted on the searchable database etc. or he can simply have the GPR sent directly to any email address he likes without being a member of our site. He earns no points at that time. The Receiver can join the system at any time and the Unique Code will remain good for some period of time allowing him to associate the comments he has received even as a non-member to still be available to earn points towards his new GPR Score once he joins.

### Filing Reports on Places

One aspect of embodiments of the present invention allows a member to also file reports on places such as restaurants, retail stores, cities, countries, doctors' offices, hospitals, etc. In some embodiments of the present invention, the system only allows a member to file a report on a place if the member is physically located at or near that place (as reported, for example, by location services information such as a global positioning system component of the member's mobile device). In other embodiments of the present invention, the system also allows members to file a report if they also provide a code associated with the place (e.g., as printed on a receipt or as shown on a sign at the place, examples of which are illustrated in FIG. 2).

If the “place” is already registered with the system, then the reports are automatically posted to the account associated with the place and representatives of the place may accept or reject the reports in a manner similar to that described above with members accepting and rejecting reports posted to their personal accounts. If the place is not already registered with the system, the reports may be reviewed by a third party (e.g., a moderator employed by an operator of the social scoring system according embodiments of the present invention) to determine whether or not the report should be approved. For example, the third party may evaluate whether the report meets a “standard of good” (e.g., that the report speaks about the place is a sufficiently positive light). In other embodiments, the reports about places that are not already members may be automatically published and accessible by other members or the public. Published reports about places may also be flagged by readers of the reports for further review when those reports are considered inappropriate (e.g., failing to meet the “standard of good”).

A “standard of good” may be enforced by a system that clearly states the policy to members who file reports. Moderators may review reports (e.g., randomly) to flag reports that may not be compliant. In addition, members may flag inappropriate reports that do not comply with the “standard of good” and a natural language analysis tool may automatically identify and flag reports that do not meet the “standard of good” based on, for example, keyword matching. Members who file reports that do not meet the “standard of good” may have their scores reduced by the moderators or may have their accounts suspended or terminated.

### Filing Reports on Products

Aspects of embodiments of the present invention allow a member to also file reports on products. Products can be identified in a number of ways, such as by taking a photograph of the product, scanning a bar code on the product or its packaging, searching for the product itself within a database of known products, or creating a new entry in a database if no matching entry exists, where the entry may be categorized (e.g., a television category versus a food products category). In addition, in some embodiments, if the particular model of the product is unavailable (e.g., the particular model of television cannot be identified), then the report may be added to a general category (e.g., “televisions”).

### Filing Reports on Play

One aspect of embodiments of the present invention allows a member to also file reports on “play,” which includes entertainment such as books, movies, music, television shows, concerts, and other types of events. In a manner similar to that described above, owners of the “play,” other members, and third party moderators may evaluate and flag the reports filed on entertainment to ensure that they are within the “standard of good”.

### Limits on Filing

In some embodiments of the present invention, the system limits the frequency at which any particular Giver can give GPRs to any particular person, place, product, or play, thereby reducing the degree to which users can inflate a score by repeatedly giving GPRs to the same person, place, product, or play. For example, while a mother may truly believe that her daughter is wonderful, in some embodiments of the present invention, the system may prevent the mother from filing a thousand GPRs every month on her daughter by limiting all users to filing a limited number of GPRs on a person, place, product, or play in a given time period (e.g., day, week, month, etc.)

### Corporate Members

As discussed above, some members may correspond to non-persons such as corporations, which may have ownership of certain types of profiles such as those about products, places, and play. Generally, there may be two types of corporate members: retail and non-retail.

In some aspects of embodiments of the present invention, a retail member may use a social scoring system according to one embodiment of the present invention to manage customer satisfaction with employees and locations. For example, in one embodiment, each employee may wear a name tag (e.g., as shown in FIG. 2) identifying their personally assigned code or other identifying feature. When a customer or another employee wants to file a GPR on a recipient employee, they can scan the employee's personal code into their app or use the recipient's thumbprint or other biometric feature. The report with good comments may then be automatically associated with the Receiver, as described above. The Receiver may then read, listen to, or watch the comments and approve or reject those comments. If the Giver has allowed their identifying information to be seen by the Receiver, the Receiver may choose to send a thank you note, photo, card, audio, video, etc.

In some aspects of embodiments of the present invention, each location of retail member may also be assigned an identifying code (e.g., as shown in FIG. 2). This code may be promoted throughout the location and on the customer's sales receipt. A customer may then file a report regarding the location. The customer's patronage of the retail location can be verified either by confirming the user's geographic position or by the scanning of the code assigned to that retail location.

In addition, non-retail corporate members can use a social scoring system according to one embodiment of the present invention to assist with team building. Employees may be encouraged to file reports on one another when they recognize other members performing good deeds. Employers may then organize incentives based on people or departments having the highest scores. For example, cross promotions with other companies may result in rewarding high scoring employees with gift certificates at coffee shops. Other corporate clients may be arranged to compete with one another for the highest scores. In some embodiments of the present invention, a company may deploy an independent instance of the system for use within the company for team-building purposes and to monitor employee status.

In addition, social scoring system according to embodiments of the present invention may augment a company's human resources department or an outside employment agency by helping employees identify potential good candidates to the company.

### Searching a Database to Review Reports

According to some embodiments of the present invention, users (whether members or not) can search the database of profiles and reports for people, places, products, or play, as illustrated in FIGS. 3G and 5F. In addition, in some embodiments of the present invention, people are only included in the searchable database if they pay a fee. In other embodiments of the present invention, a fee is not required for a person to be included in the searchable database.

In some embodiments of the present invention, the reports for people, places, products, and play are stored in separate searchable databases. The database may automatically generate rankings of the evaluated people, products, places, and play, and the resulting top scoring items may be shown in leaderboards as shown, for example, in FIG. 3H. In some embodiments of the present invention, searching for reports may allow searching based on criteria including: number of PRs filed; industry; location; subject; and attributes (e.g., terms found in reports such as “kind,” “patient,” “aggressive,” “helpful,” “out of his/her way,” “a good husband,” “delicious,” “great atmosphere,” and “good for kids.”)

The user's search criteria may also be categorized so that a user can see the results in order of ranking of search terms. For example, if the user searched for “Baseball coach in Glendale,” there may be ten matches with a total of 260 reports filed between all of the matches. Embodiments of the present invention may categorize the most frequently used terms in from the reports filed. For example, the system may identify that “professional” was found in 13 reports, “kind” was found in 8 reports, and “reliable” was found in 25 reports. In addition, reports for individuals may be divided by category.

After identifying a list of people matching the given criteria, searching user may read or listen to all of the reports about each person and may save the matches that they like for review later. If the people in the matches have given permission, contact information such as an email address may be included next to each person's entry in the displayed list. Similarly, places can have any contact information such as physical or mailing addresses, email addresses, and phone numbers and may also include links (as indicated by the rectangles near the right side of each match in the list in FIG. 3H) to book appointments (e.g., make restaurant reservations or book plane tickets), to order products (e.g., purchase concert tickets), to enter immediate video conferencing, or to book an interview (e.g., to interview potential job candidates through live video conferencing). Links for places may also lead to more information, such as a website for the place. A product link may allow the searcher to purchase the product or to identify retail locations to purchase the product. A play link may allow the searcher to buy the play (e.g., book, song, movie, etc.).

If the owner of a profile has provided permission and contact information, a member may send a message to other members, based on the profile owner's preferences. These communication channels may include a direct message on the social scoring system, an email, a text message, a telephone call (which may automatically access a dialing function on the user's device), a Twitter® tweet or direct message, and a Facebook® message. Similarly, the searching user may request a response by any of a variety of communication channels such as email, phone, text message, Twitter® tweet or direct message, and a Facebook® message. In addition, the ability to contact another member may be restricted to people who are less than a particular distance apart (e.g., one mile), or based on a specific location such as a particular city, region, or state.

According to one embodiment of the present invention, a member may search for reports that were filed on products (e.g., when considering various models or when seeking information about the best model to purchase). As such, embodiments of the present invention allow a user to search for reports about a given product by scanning a bar code on a product (e.g., a product on display at a store). In addition, some embodiments of the present invention allow viewing the top products in a particular category (e.g., highest scoring televisions). Furthermore, the searches may include keywords based on terms that were extracted from the reports filed about the product. Such terms may include, for example, “good picture” and “reliable” for televisions and “low sugar” and “good for school lunches” for food products. This differs from review services which review a product as a whole. In embodiments of the present invention, various features or aspects of products that appeal to different Givers for their own personal reasons may be identified. For example, a particular cereal may be listed. In a review system that considered the product as a whole, a reviewer may write that the cereal is sweet. In a system according to embodiments of the present invention, a report may write “I like this cereal because it tastes good and my kids love to eat it for breakfast.” Another report regarding this cereal in a system according to embodiments of the present invention may read “this product reminds me of the old days when I was a kid—it makes me feel good.” The reviews may not necessarily be about the product and its features, but rather may be based on why it is good to the Giver of the report. Because the reports are given based on positive aspects of products, the descriptive, positive features regarding what the product is (e.g., it is pleasingly sweet) emerge from the reports, whereas systems that accept negative reviews of the product as a whole may include confusingly similar terms. For example, a first review that stated “this cereal is cloyingly sweet” and a second review that stated “this cereal is perfectly sweet” would both indicate that the cereal is “sweet,” but the two reviews reflect completely different regarding its “sweetness.” On the other hand, in embodiments of the present invention, where reports on products only include positive remarks, repeated comments about the sweetness of the cereal suggest that it is sweet in a good way.

Aspects of embodiments of the present invention also allow a user to view the profiles of the members who filed reports on the people, products, places, or play that appeared in the search results. From there, the member may ask the report Givers further questions about those products.

In addition, some aspects of embodiments of the present invention provide links from the profile pages of products, places, and play to ways to purchase or view the products, places, or play. For example, product pages may include links to purchase the products from a variety of vendors (each of which may have their own scores and associate profile pages). For example, a place page for a vacation destination may include a link to travel agency, a place page for a mechanic or other service provide may provide a link to schedule an appointment, and a place page For a restaurant may include a link for making a reservation. A play profile page may include a link to purchase a CD or DVD of the item or to an online source from which the item can be purchased for download or streaming or saved to an online library such as Spotify® or iTunes®.

### Data Analysis

In one aspect of embodiments of the present invention, the scores captured by the system can be used to predict the general “mood” of an economy, or particular sectors or industries therein. Current tools for predicting and analyzing financial markets are based largely on trends that have been seen or measured in the past. In contrast, embodiments of the present invention can provide data that can predict market shifts based on the number of reports filed within, for example, a location, an industry, and at a particular company. In addition, scores can be broken down into details about why shoppers are shopping (e.g., what is making them happy, what is making them buy at a particular store). Example, if one hundred GPRs were filed in a week on salespeople in a department store, keywords will allow us to be able to report to department store's management that certain things are making their customers happy. If thirty-five GPRs stated that the salesperson was smiling and pleasant and forty said the sales person went out of their way to find a certain item the shopper was looking for, systems according to embodiments of the present invention can report to the department store management that smiling and searching for products had a significant impact on why their customers are happy shopping at their store Embodiments of the present invention may also report to the department store not just why their customers are happy and whose customers are happier, but also why their customers are happy and why their competitors' customers are happy.

Embodiments of the present invention may incorporate the aggregated scores into mathematical models to forecast market trends and to supply various economic indicators in all aspects of the market. For example, high scores for a product may be associated with customer satisfaction and can show effects before the sales actually happen. High scores may also be shown to relate to the number of people shopping and areas with high foot traffic and high sales/profit. The frequency with which reports are left may be correlated with general happiness and/or contentment, which may also be analyzed based on particular economies across the world. As such the scores may be used to “foreshadow” specific sectors in a given market (such as a store) or may “foreshadow” how many people in an area or location are feeling and how that will affect a particular economy.

Comparing average scores on a number of scales (e.g., locally versus globally) can also provide insight into current economic conditions. For example, comparing the scores given to employees at different locations (e.g., different cities in the same state or between different countries) of a retail department store or fast food restaurant can be used to track employee performance at and/or customer satisfaction with those stores. Similarly, customer satisfaction with different chains of stores (e.g., Wal-Mart versus Target) in similar locations can also be tracked based on the scores of those chains.

Maps and graphs of the scores over dine and comparing, for example, scores in different locations or between industries may be provided to corporate decision makers. In addition global graphs of scores around the world may be provided to show happiness around the world at any given time.

Reports generated using the aggregated scores may also be available for purchase. For example, scores of employees can be used to monitor customer satisfaction with particular employees, customer satisfaction employees as an aggregated whole, and customer satisfaction with an entire establishment and/or brand.

FIG. 5G is a flowchart illustrating methods for a retail store, its customers, and its employees to interact with a system according to one embodiment of the present invention.

FIG. 5H is a flowchart illustrating a method for various revenue models for monetizing a system according to one embodiment of the present invention.

Aspects of embodiments of the present invention may be implemented on personal computing devices such as smartphones and personal digital assistants. Such personal computing devices may include a processor and memory storing instructions to be executed by the processor, where the memory may include instructions implementing aspects of embodiments of the present invention. The personal computing devices may include a camera, a microphone, a display, a user input device (e.g., a touch sensitive panel and buttons), and a network adapter (e.g., a cellular modem and/or a Wi-Fi modem) configured to connect the personal computing devices to a network such as the Internet.

Aspects of embodiments of the present invention may also be implemented on one or more server computer devices that include a processor and memory storing instructions to be executed by the processor, where the memory may include instructions implementing aspects of embodiments of the present invention. The server computing devices may also include a persistent storage device which may store one or more databases. The server computing devices may include network adapters configured to connect the server computing devices to a network such as the Internet.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

For example, according to some embodiments of the present invention, unlike a rating system in which people need to ask others to rate them (e.g., restaurants asking their customers to write review on a restaurant review service), embodiments of the present invention can suggest ways for users to increase their scores, such as by providing volunteer opportunities with organizations that offer to file positive reports on people in exchange for volunteering their time. Similarly, as a form of advertisement, businesses may offer to file reports in exchange for patronage. As such, embodiments of the present invention may offer users a multitude of ways to increase their scores by doing well throughout their communities.

What is claimed is:

1. A method for receiving and publishing reports, comprising the steps of:
creating a profile for a receiving entity, wherein the profile is stored in a database;
receiving, by a processor, a report from a giving user regarding the receiving entity;
generating, by the processor, a report code associated with the report;
associating, by the processor, the report code with the profile of the receiving entity;
receiving from the receiving entity, by the processor, an approval or a rejection of the report associated with the report code; and
publishing, by the processor, the report on the profile of the receiving entity, it the processor received approval of the report from the receiving entity.

2. The method for receiving and publishing reports of claim 1, further comprising, the step of deleting reports rejected by the receiving entity.

3. The method for receiving and publishing reports of claim 1, further comprising, the step of associating reports rejected by the receiving entity with the receiving entity's profile and storing those reports in the database.

4. The method for receiving and publishing reports of claim 3, further comprising, the step of suppressing the publication in the receiving entity's profile of those reports stored in the database, but rejected by the receiving entity.

5. The method for receiving and publishing reports of claim 1, further comprising, the step of creating a profile for the giving user.

6. The method for receiving and publishing reports of claim 1, further comprising, the step of recording in the profile of the giving user the number of reports submitted by the giving user and rejected by the receiving entity.

7. The method for receiving and publishing reports of claim 6, further comprising, the step of flagging for review the profile of the giving user when the number of reports submitted by the giving user and rejected by the receiving entity exceed a predetermined number.

8. The method for receiving and publishing reports of claim 6, further comprising, the step of deleting the profile of the giving user when the number of reports submitted by the giving user and rejected by the receiving entity exceed a predetermined number.

9. The method for receiving and publishing reports of claim 1, further comprising the step of providing the receiving entity with the option to selectively hide from publication portions of the report received from the giving user in the alternative to rejecting the report.

10. The method for receiving and publishing reports of claim 9, further comprising, providing a status indicator operable to show in the receiving entity's profile, when the receiving entity has selectively hidden from publication portions of the report received from the giving user.

11. The method for receiving and publishing reports of claim 10, further comprising, the step of making the status indicator selectively operable by a system operator as to whether to show the status indicator in the receiving entity's profile, when the receiving has selectively hidden from publication portions of the report received from the giving user.

12. The method for receiving and publishing reports of claim 1, further comprising, the step of scanning for preselected keywords, a plurality of reports received by a receiving entity from one or more giving users.

13. The method for receiving and publishing reports of claim 12, further comprising, the step of tabulating the number of occurrences of the preselected keywords, found in the plurality of reports received and not rejected by the receiving entity from one or more giving users.

14. The method for receiving and publishing reports of claim 13, further comprising, the step of calculating a score for the receiving entity based upon a predetermined algorithm which uses the tabulated the number of occurrences of the preselected keywords, found in the plurality of reports received and not rejected by the receiving entity from one or more giving users.

15. A method for receiving and publishing reports, comprising the steps of:
creating a profile for a receiving entity, wherein the profile is stored in a database;
receiving, by a processor, at least one report from at least one giving user regarding the receiving entity;
generating, by the processor, a report code associated with each at least one report; associating, by the processor, each report code with the profile of the receiving entity;
receiving from the receiving entity, by the processor, an approval or a rejection of each of the at least one report associated with each report code;
publishing, by the processor, each of the at least one report on the profile of the receiving entity, if the processor received approval for each of the at least one report from the receiving entity;
scanning for preselected keywords, each of the at least one report received by a receiving entity from each of the at least one giving user.
tabulating the number of occurrences of the preselected keywords, found in each of the at least one report received and not rejected by the receiving entity from the at least one giving user; and
calculating a score for the receiving entity based upon a predetermined algorithm which uses the tabulated number of occurrences of the preselected keywords, found in each of the at least one report received and not rejected by the receiving entity from each of the at least one giving user.

16. The method for receiving and publishing reports of claim 15, further comprising the step of providing the receiving entity with the option to selectively hide from publication portions of each of the at least one report received from each of the at least one giving user in the alternative to rejecting each of the at least one report.

17. The method for receiving and publishing reports of claim 16, further comprising, providing a status indicator operable to show in the receiving entity's profile, when the receiving entity has selectively hidden from publication portions of the at least one report received from the at least one giving user.

18. The method for receiving and publishing reports of claim 17, further comprising, the step of making the status indicator selectively operable by a system operator as to whether to show the status indicator in the receiving entity's profile, when the receiving entity has selectively hidden from publication portions of the at least one report received from the at least one giving user.

19. The method for receiving and publishing reports of claim 15, wherein the receiving entity is selected from the group comprising individuals, business entities, locations or plays.

20. The method for receiving and publishing reports of claim 15, further comprising the step of creating a profile for each of the at least one giving user; recording in the profile of each of the at least one giving user the number of the at least one report submitted by each of the at least one giving user and rejected by the receiving entity; and flagging for review the profile of each of the at least one giving user when the number of reports submitted by the at least one giving user and rejected by the receiving entity exceed a predetermined number.
